(19) United States
(12) Patent Application Publication
(10) Pub. No.: US 2026/0322103 A1
(43) Pub. Date: Oct. 15, 2026

(54) SEMICONDUCTOR DEVICE, ELECTRONIC DEVICE, AND VEHICLE

(71) Applicant: ROHM CO., LTD., Kyoto-shi (JP)

(72) Inventors: Kenji MURAOKA, Kyoto-shi (JP); Joita ADRIAN, Kyoto-shi (JP); Toru TAKUMA, Kyoto-shi (JP)

(21) Appl. No.: 19/685,403

(22) Filed: May 22, 2026

Related U.S. Application Data
(63) Continuation of application No. PCT/JP2024/040675, filed on Nov. 15, 2024.

(30) Foreign Application Priority Data
Nov. 27, 2023 (JP) 2023-199828

(51) Int. Cl. H02H 3/08; B60R 16/023; H02H 1/00

(52) U.S. Cl. CPC H02H 3/08; B60R 16/0231; H02H 1/0007

(57) ABSTRACT

An overcurrent protection circuit restricts an output current to an overcurrent protection threshold value or less until a voltage across an output switch falls below a detection threshold value after reception of an instruction to turn on the output switch. After the voltage across the output switch falls below the detection threshold value, the overcurrent protection circuit forcibly turns off the output switch when the output current exceeds an overcurrent protection threshold value and releases the forcibly turning off when the output current falls below the overcurrent protection threshold value. After the number of times the output switch is forcibly turned off reaches an upper limit after the voltage across the output switch falls below the detection threshold value, the overcurrent protection circuit forcibly turns off the output switch when the output current exceeds the overcurrent protection threshold value and releases the forcibly turning off when a time has elapsed.

### CROSS REFERENCE TO RELATED APPLICATIONS

This application is a continuation under 35 U.S.C. § 120 of PCT/JP 2024/040675, filed Nov. 15, 2024, which is incorporated herein by reference, and which claimed priority to Japanese Application No. 2023-199828, filed Nov. 27, 2023. The present application likewise claims priority under 35 U.S.C. § 119 to Japanese Application No. 2023-199828, filed Nov. 27, 2023, the entire content of which is also incorporated herein by reference.

### TECHNICAL FIELD

The present disclosure relates to a semiconductor device, an electronic device and a vehicle.

### BACKGROUND ART

The applicant of the present application has proposed a large number of new techniques semiconductor devices called an IPD [intelligent power device] and an SPS [smart power switch] (see, for example, Patent Document 1).

### RELATED ART DOCUMENT

### Patent Document

Patent Document 1: International Publication No. 2017/187785 Brief Description of Drawings

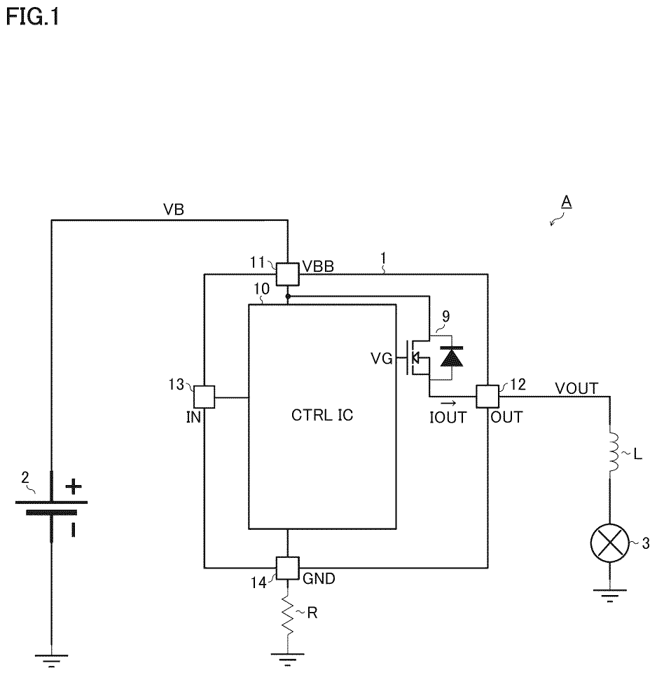

FIG. 1 is a diagram showing an example of the configuration of an electronic device which includes a semiconductor device;

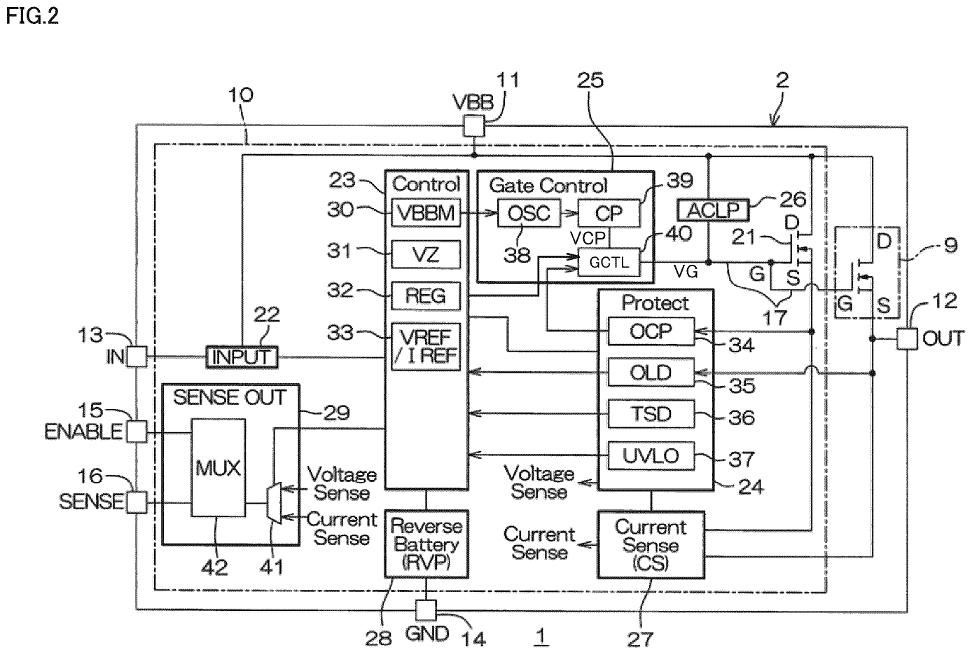

FIG. 2 is a diagram showing a first embodiment of the semiconductor device;

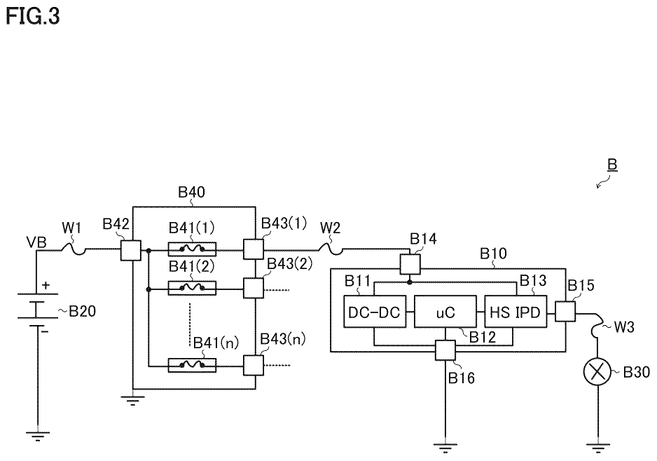

FIG. 3 is a diagram showing an example of an electronic device which includes mechanical fuses;

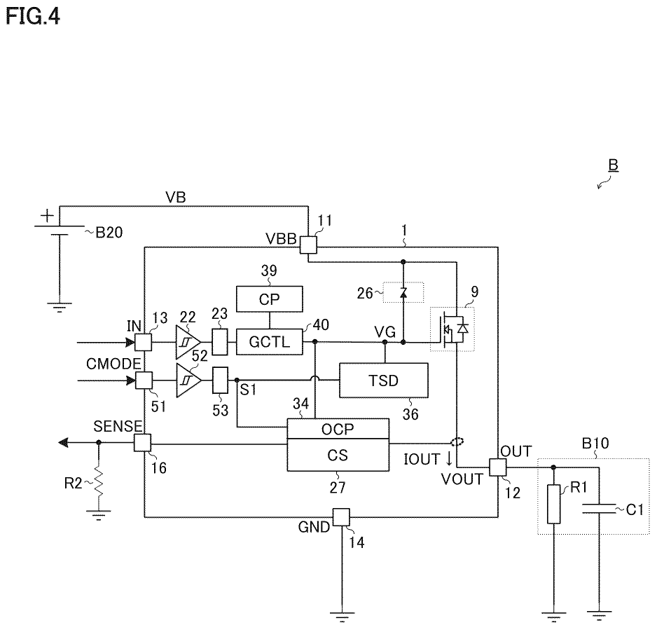

FIG. 4 is a diagram showing a second embodiment of the semiconductor device;

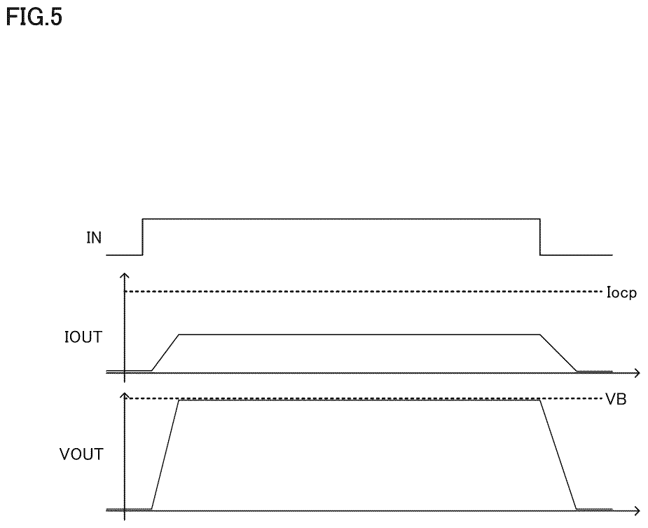

FIG. 5 is a diagram showing a first example of an abnormality protection operation;

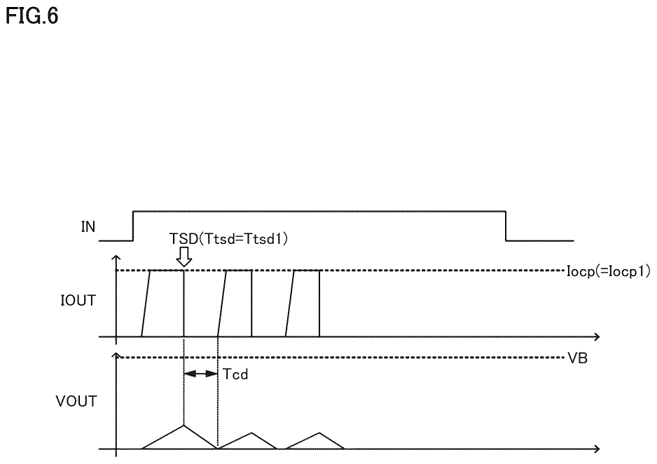

FIG. 6 is a diagram showing a second example of the abnormality protection operation;

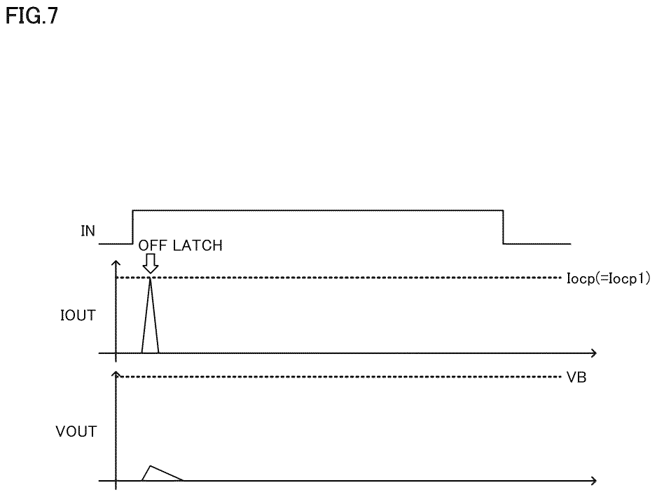

FIG. 7 is a diagram showing a third example of the abnormality protection operation;

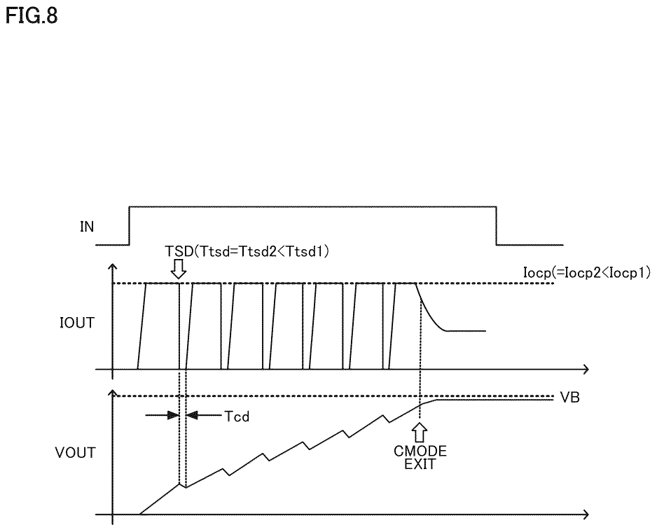

FIG. 8 is a diagram showing a fourth example of the abnormality protection operation;

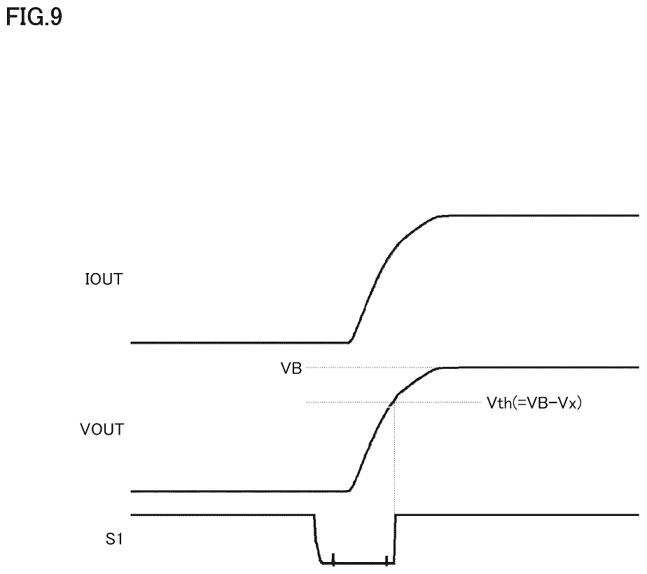

FIG. 9 is a diagram showing a first example of a startup operation in the second embodiment;

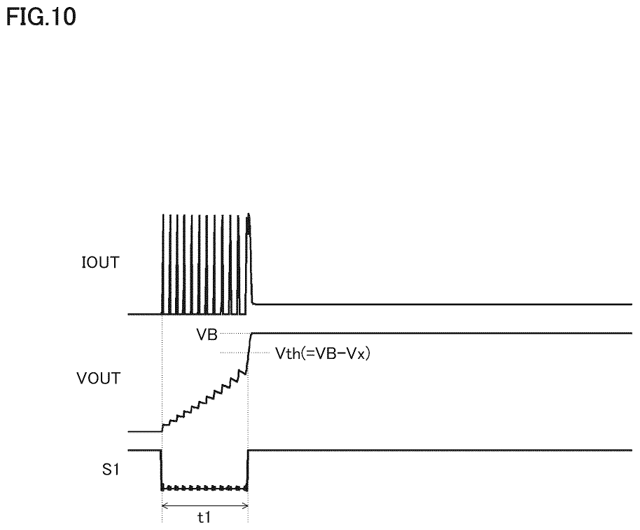

FIG. 10 is a diagram showing a second example of the startup operation in the second embodiment;

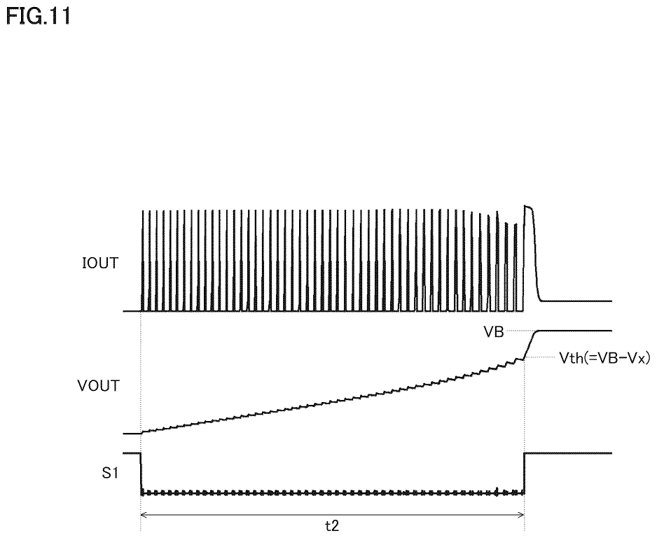

FIG. 11 is a diagram showing a third example of the startup operation in the second embodiment;

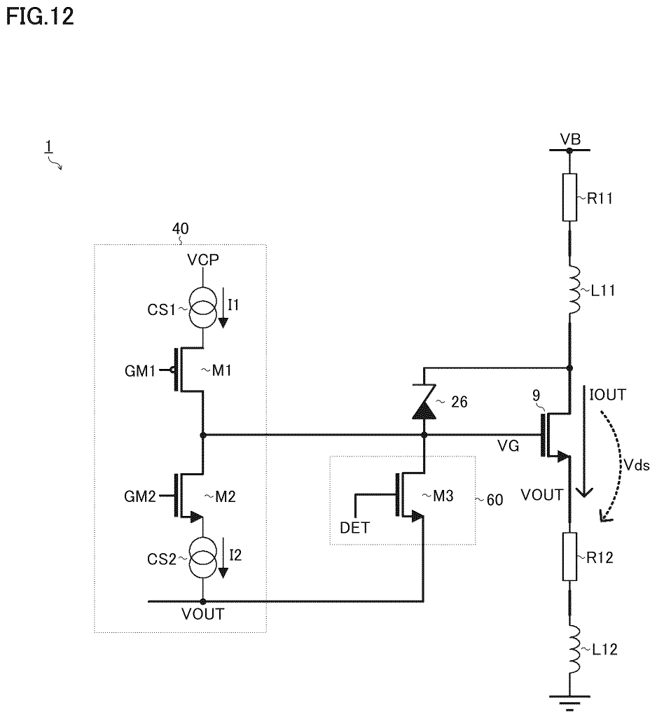

FIG. 12 is a diagram showing a third embodiment of the semiconductor device;

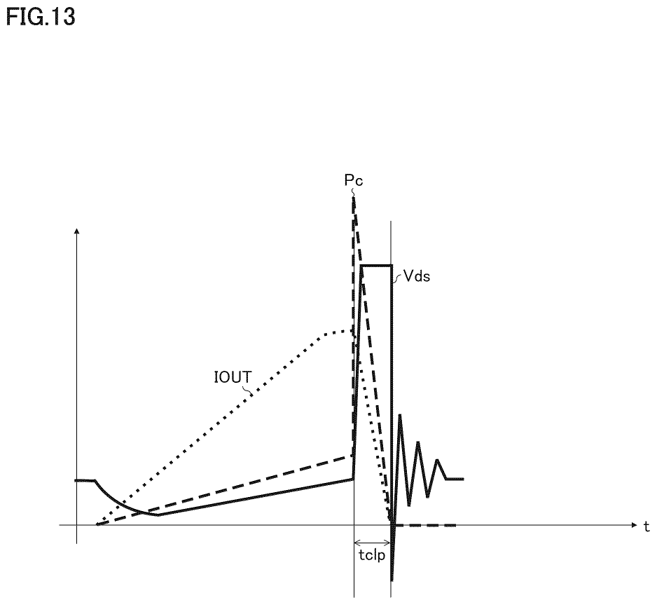

FIG. 13 is a diagram showing a turn-off behavior in the third embodiment;

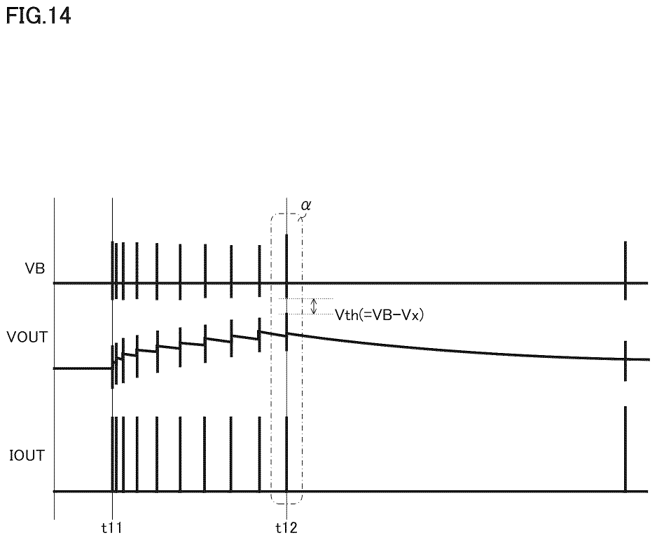

FIG. 14 is a diagram showing a startup behavior in the third embodiment;

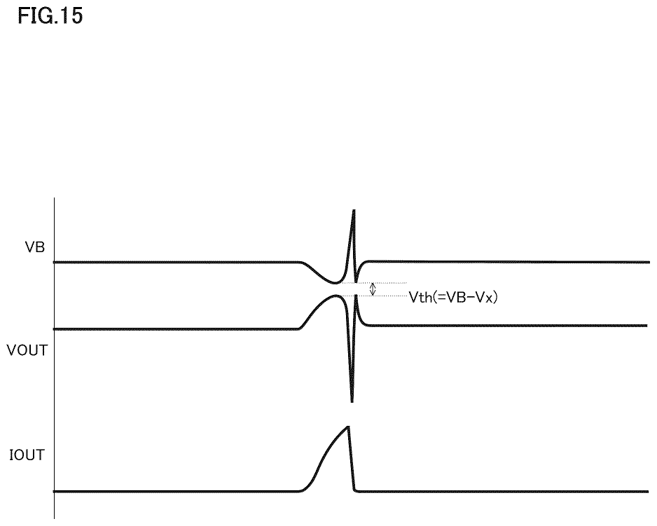

FIG. 15 is an enlarged view of a part of FIG. 14;

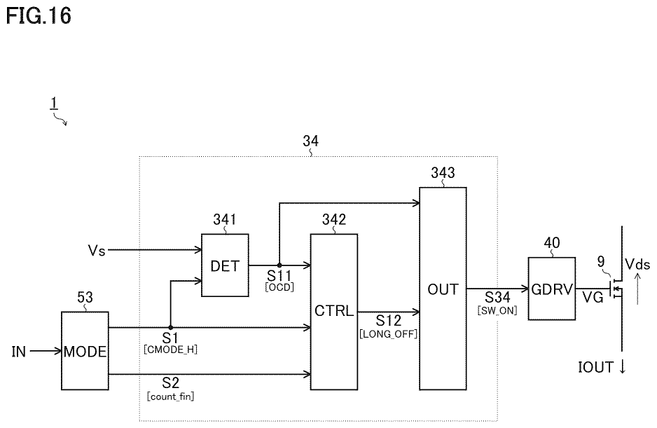

FIG. 16 is a diagram showing a fourth embodiment of the semiconductor device;

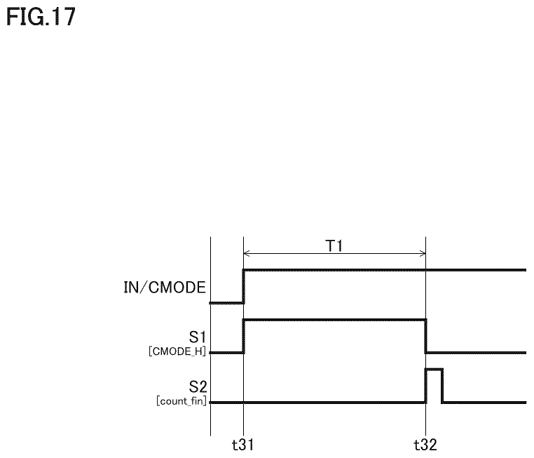

FIG. 17 is a diagram showing an example of generation of a count completion signal;

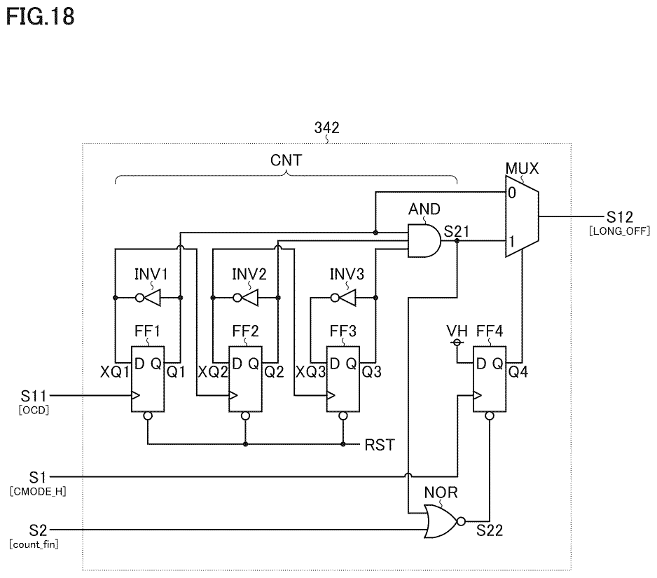

FIG. 18 is a diagram showing an example of the configuration of a control circuit;

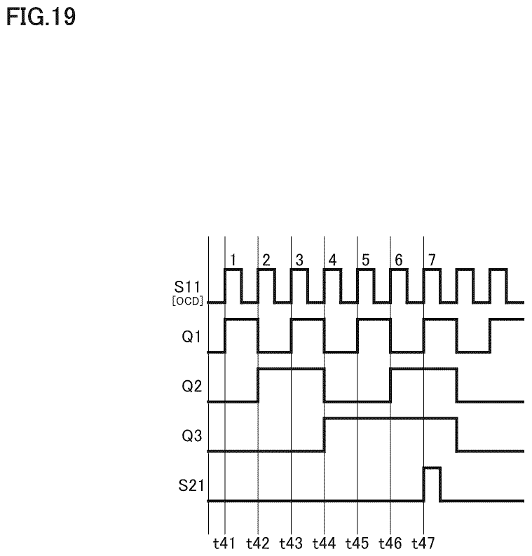

FIG. 19 is a diagram showing an example of generation of an upper limit count reaching signal;

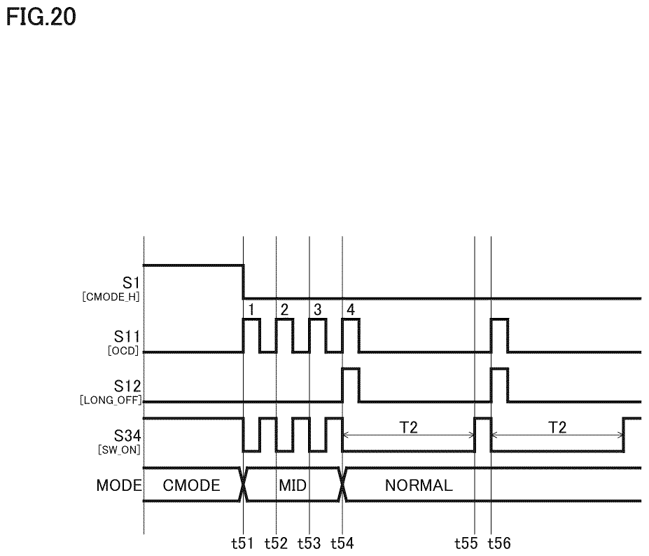

FIG. 20 is a diagram showing an example of a mode transition;

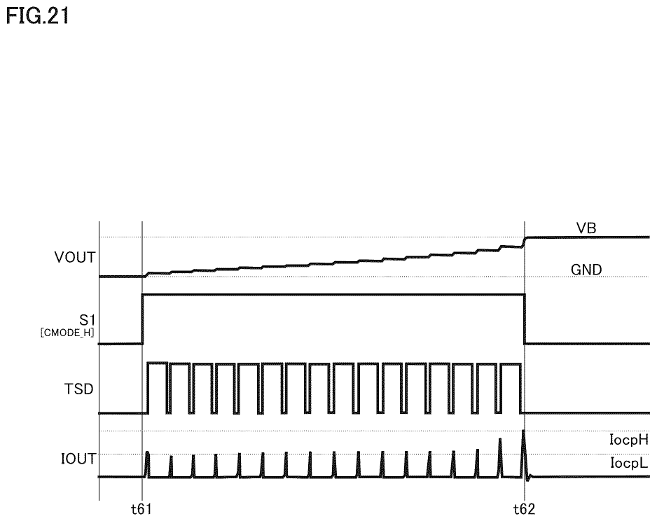

FIG. 21 is a diagram showing a first example of a startup operation in the fourth embodiment;

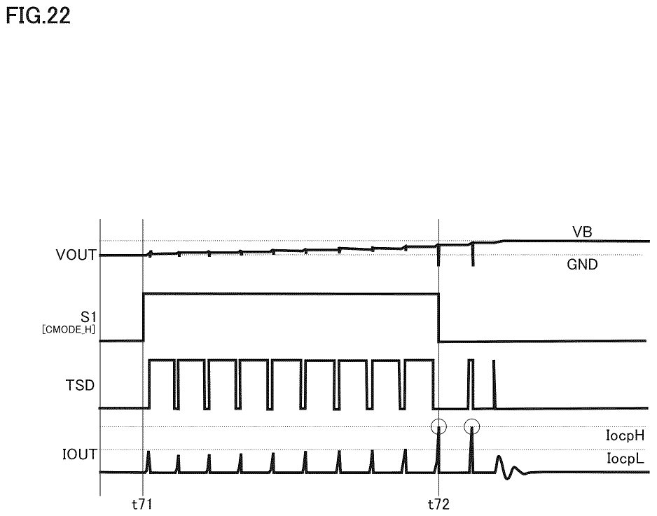

FIG. 22 is a diagram showing a second example of the startup operation in the fourth embodiment;

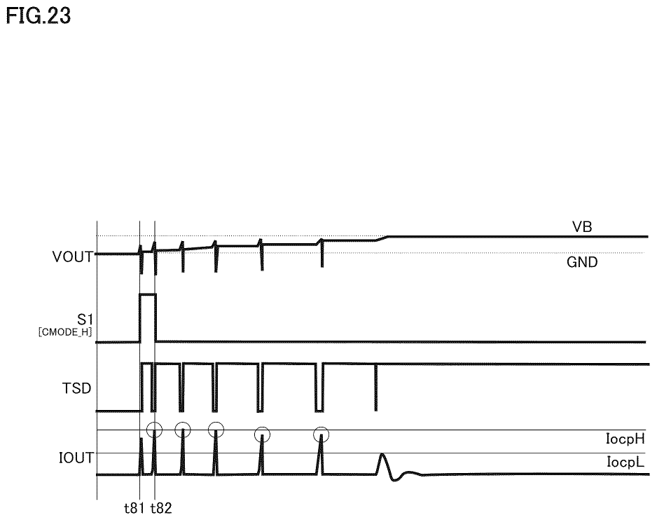

FIG. 23 is a diagram showing a third example of the startup operation in the fourth embodiment; and

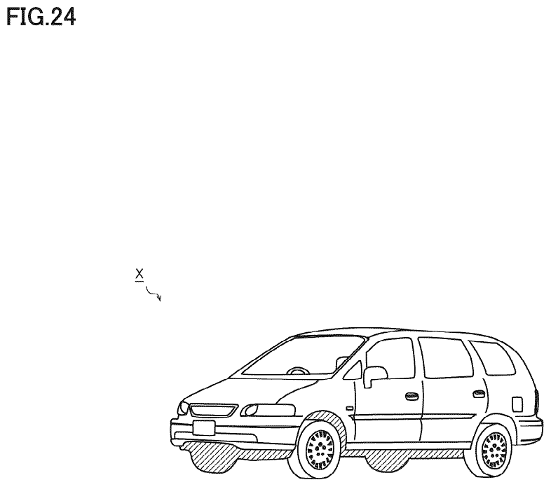

FIG. 24 is a diagram showing the appearance of a vehicle.

### DESCRIPTION OF EMBODIMENTS

### Detailed description

### Electronic Device

FIG. 1 is a diagram showing an example of the configuration of an electronic device which includes a semiconductor device. The electronic device A of the present configuration example includes a semiconductor device 1, a direct-current power supply 2 and a load 3.

The semiconductor device 1 is a high-side switch IC (a type of IPD) which electrically conducts or interrupts between the direct-current power supply 2 and the load 3, and integrates a power MISFET [metal insulator semiconductor field effect transistor] 9 and a controller 10.

The semiconductor device 1 includes a plurality of external electrodes as a means for establishing electrical connection with the outside of the device. With reference to the figure, the semiconductor device 1 includes a drain electrode 11 (corresponding to a power supply electrode VBB), a source electrode 12 (corresponding to an output electrode OUT), an input electrode 13 (corresponding to an input electrode IN) and a reference voltage electrode 14 (corresponding to a ground electrode GND).

The power MISFET 9 is an example of an insulated gate power transistor (=output switch), and functions as a high-side switch element which electrically conducts or interrupts between the drain electrode 11 and the source electrode 12.

The controller 10 includes a plurality of types of function circuits which realize various functions. Examples of the various types of function circuits include a circuit which generates a gate drive signal VG for driving and controlling the power MISFET 9 based on an electrical signal from the outside.

The drain electrode 11 transmits a power supply voltage VB to the drain of the power MISFET 9 and various types of circuits in the controller 10. The source electrode 12 is connected to the source of the power MISFET 9 and transmits an output voltage VOUT and an output current IOUT to the load 3. A signal line (for example, a wire harness) provided between the source electrode 12 and the load 3 generally has an inductance component L (and a resistance component). The input electrode 13 transmits an input voltage (input signal) for driving the controller 10. The reference voltage electrode 14 transmits a reference voltage (for example, a ground voltage) to the controller 10. A resistance component R is generally present between the reference voltage electrode 14 and a ground end.

Semiconductor Device (First Embodiment) FIG. 2 is a diagram showing a first embodiment of the semiconductor device 1 (=the electrical structure of the semiconductor device 1 shown in FIG. 1). In the following description, a case where the semiconductor device 1 is installed in a vehicle is used as an example. When the semiconductor device 1 is installed in the vehicle, the semiconductor device 1 can be applied as a high-side switch for controlling the energization of a light source such as a bulb lamp or an LED [light emitting diode] lamp or another type of electronic control device.

The semiconductor device 1 includes the drain electrode 11, the source electrode 12, t input electrode 13, the reference voltage electrode 14, an enable electrode 15, a sense electrode 16, a gate control wire 17, the power MISFET 9 and the controller 10.

The drain electrode 11 (=power supply electrode VBB) is connected to the direct-current power supply 2. The drain electrode 11 provides the power supply voltage VB to the power MISFET 9 and the controller 10. The power supply voltage VB may be equal to or greater than 10 V and equal to or less than 20 V. On the other hand, the source electrode 12 (=output electrode OUT) is connected to the load 3.

The input electrode 13 (=input electrode IN) may be connected to a MCU [micro controller unit], a DC/DC converter, an LDO [low drop out] regulator and the like. The input electrode 13 provides an input voltage to the controller 10. The input voltage may be equal to or greater than 1 V and equal to or less than 10 V. The reference voltage electrode 14 is connected to a reference voltage wire (ground end). The reference voltage electrode 14 provides the reference voltage to the power MISFET 9 and the controller 10.

The enable electrode 15 may be connected to the MCU. An electrical signal for enabling or disabling a part or all of functions of the controller 10 is input to the enable electrode 15. The sense electrode 16 transmits an electrical signal for detecting an abnormality of the controller 10 to the outside of the device. The sense electrode 16 may be pulled up or down by a resistor.

The gate of the power MISFET 9 is connected to the controller 10 (in particular, a control circuit 25 which will be described later) via the gate control wire 17. The drain of the power MISFET 9 is connected to the drain electrode 11. The source of the power MISFET 9 is connected to the controller 10 (in particular, a current detection circuit 27 which will be described later) and the source electrode 12.

The controller 10 includes a sensor MISFET 21, an input circuit 22, a current/voltage control circuit 23, a protection circuit 24, the gate control circuit 25, an active clamp circuit 26, the current detection circuit 27, a power supply reverse connection protection circuit 28 and an abnormality detection circuit 29.

The gate of the sensor MISFET 21 is connected to the gate control circuit 25. The dr of the sensor MISFET 21 is connected to the drain electrode 11. The source of the sensor MISFET 21 is connected to the current detection circuit 27.

The input circuit 22 is connected to the input electrode 13 and the current/voltage control circuit 23. The input circuit 22 may include a Schmitt trigger circuit. The input circuit 22 shapes the waveform of an electrical signal applied to the input electrode 13. A signal generated by the input circuit 22 is input to the current/voltage control circuit 23.

The current/voltage control circuit 23 is connected to the protection circuit 24, the gate control circuit 25, the power supply reverse connection protection circuit 28 and the abnormality detection circuit 29. The current/voltage control circuit 23 may include a logic circuit.

The current/voltage control circuit 23 generates various voltages according to the electrical signal from the input circuit 22 and an electrical signal from the protection circuit 24. In this form, the current/voltage control circuit 23 includes a drive voltage generation circuit 30, a first constant voltage generation circuit 31, a second constant voltage generation circuit 32 and a reference voltage/reference current generation circuit 33.

The drive voltage generation circuit 30 generates a drive voltage for driving the gate control circuit 25. The drive voltage may be set to a value obtained by subtracting a predetermined value from the power supply voltage VB. The drive voltage generation circuit 30 may generate the drive voltage which is obtained by subtracting 5 V from the power supply voltage VB and is equal to or greater than 5 V and equal to or less than 15 V. The drive voltage is input to the gate control circuit 25.

The first constant voltage generation circuit 31 generates a first constant voltage for driving the protection circuit 24. The first constant voltage generation circuit 31 may include a Zener diode or a regulator circuit (here, the Zener diode). The first constant voltage may be equal to or greater than 1 V and equal to or less than 5 V. The first constant voltage is input to the protection circuit 24 (more specifically, a load open detection circuit 35 which will be described later or the like).

The second constant voltage generation circuit 32 generates a second constant voltage for driving the protection circuit 24. The second constant voltage generation circuit 32 may include a Zener diode or a regulator circuit (here, the regulator circuit). The second constant voltage may be equal to or greater than 1 V and equal to or less than 5 V. The second constant voltage is input to the protection circuit 24 (more specifically, an overheat protection circuit 36 and a low voltage malfunction suppression circuit 37 which will be described later).

The reference voltage/reference current generation circuit 33 generates the reference voltage and a reference current for various types of circuits. The reference voltage may be equal to or greater than 1 V and equal to or less than 5 V. The reference current may equal to or greater than 1 mA and equal to or less than 1 A. The reference voltage and the reference current are input to various types of circuits. When the various types of circuits include a comparator, the reference voltage and the reference current may be input to the comparator.

The protection circuit 24 is connected to the current/voltage control circuit 23, the gate control circuit 25, the abnormality detection circuit 29, the source of the power MISFET 9 and the source of the sensor MISFET 21. The protection circuit 24 includes an overcurrent protection circuit 34, the load open detection circuit 35, the overheat protection circuit 36 and the low voltage malfunction suppression circuit 37.

The overcurrent protection circuit 34 protects the power MISFET 9 from an overcurrent. The overcurrent protection circuit 34 is connected to the gate control circuit 25 and the source of the sensor MISFET 21. The overcurrent protection circuit 34 may include a current monitor circuit. A signal generated by the overcurrent protection circuit 34 is input to the gate control circuit 25 (more specifically, a drive signal output circuit 40 which will be described later).

The load open detection circuit 35 detects the short-circuit state and the open state of power MISFET 9. The load open detection circuit 35 is connected to the current/voltage control circuit 23 and the source of the power MISFET 9. A signal generated by the load open detection circuit 35 is input to the current/voltage control circuit 23.

The overheat protection circuit 36 monitors the temperature of the power MISFET 9 protect the power MISFET 9 from an excessive temperature rise. The overheat protection circuit 36 is connected to the current/voltage control circuit 23. The overheat protection circuit 36 may include a temperature-sensitive device such as a temperature-sensitive diode or a thermistor. A signal generated by the overheat protection circuit 36 is input to the current/voltage control circuit 23.

When the power supply voltage VB is less than a predetermined value, the low voltage malfunction suppression circuit 37 suppresses the malfunction of the power MISFET 9. The low voltage malfunction suppression circuit 37 is connected to the current/voltage control circuit 23. A signal generated by the low voltage malfunction suppression circuit 37 is input to the current/voltage control circuit 23.

The gate control circuit 25 controls the on state and the off state of the power MISFET 9 and the on state and the off state of the sensor MISFET 21. The gate control circuit 25 is connected to the current/voltage control circuit 23, the protection circuit 24, the gate of the power MISFET 9 and the gate of the sensor MISFET 21.

The gate control circuit 25 outputs the gate drive signal VG to the gate control wire 17 according to an electrical signal from the current/voltage control circuit 23 and the electrical signal from the protection circuit 24. The gate drive signal VG is input via the gate control wire 17 to the gate of the power MISFET 9 and the gate of the sensor MISFET 21. More specifically, the gate control circuit 25 controls the gate drive signal VG according to the electrical signal (input signal) applied to the input electrode 13 to turn on and off the power MISFET 9.

More specifically, the gate control circuit 25 includes an oscillator circuit 38, a charge pump circuit 39 and the drive signal output circuit 40. The oscillator circuit 38 oscillates in response to an electric signal from the current/voltage control circuit 23 to generate a predetermined electrical signal. The electrical signal generated by the oscillator circuit 38 is input to the charge pump circuit 39. The charge pump circuit 39 generates a step-up voltage VCP based on the electrical signal from the oscillator circuit 38. The step-up voltage VCP generated by the charge pump circuit 39 is input to the drive signal output circuit 40.

The drive signal output circuit 40 is operated by receiving the step-up voltage VCP output from the charge pump circuit 39, and generates the gate drive signal VG according to the electrical signal from the protection circuit 24 (more specifically, the overcurrent protection circuit 34). The gate drive signal VG is input via the gate control wire 17 to the gate of the power MISFET 9 and the gate of the sensor MISFET 21. The sensor MISFET 21 and the power MISFET 9 are controlled simultaneously by the gate control circuit 25.

The active clamp circuit 26 protects the power MISFET 9 from a back electromotive force. The active clamp circuit 26 is connected to the drain electrode 11, the gate of the power MISFET 9 and the gate of the sensor MISFET 21. The active clamp circuit 26 may include a plurality of diodes.

The active clamp circuit 26 may include a plurality of diodes connected in forward bias. The active clamp circuit 26 may include a plurality of diodes connected in reverse bias. The active clamp circuit 26 may include a plurality of diodes connected in forward bias and a plurality of diodes connected in reverse bias.

The plurality of diodes may include a pn junction diode or a Zener diode, or a pn junction diode and a Zener diode. The active clamp circuit 26 may include a plurality of Zener diodes connected in forward bias. The active clamp circuit 26 may include a Zener diode and a pn junction diode connected in reverse bias.

The current detection circuit 27 detects a current flowing through the power MISFET 9 and the sensor MISFET 21. The current detection circuit 27 is connected to the protection circuit 24, the abnormality detection circuit 29, the source of the power MISFET 9 and the source of the sensor MISFET 21. The current detection circuit 27 generates a current detection signal according to an electrical signal (=output current IOUT) generated by the power MISFET 9 and an electrical signal (=sense current ISNS indicating the same behavior as the output current IOUT) generated by the sensor MISFET 21. The current detection signal is input to the abnormality detection circuit 29.

When the direct-current power supply 2 is reversely connected, the power supply reverse connection protection circuit 28 protects the current/voltage control circuit 23, the power MISFET 9 and the like from a reverse voltage. The power supply reverse connection protection circuit 28 is connected to the reference voltage electrode 14 and the current/voltage control circuit 23.

The abnormality detection circuit 29 monitors the voltage of the protection circuit 24. The abnormality detection circuit 29 is connected to the current/voltage control circuit 23 the protection circuit 24 and the current detection circuit 27. When an abnormality (such as a variation in voltage) occurs in any one of the overcurrent protection circuit 34, the load open detection circuit 35, the overheat protection circuit 36 and the low voltage malfunction suppression circuit 37, the abnormality detection circuit 29 generates an abnormality detection signal corresponding to the voltage of the protection circuit 24, and outputs it to the outside.

More specifically, the abnormality detection circuit 29 includes a first multiplexer circuit 41 and a second multiplexer circuit 42. The first multiplexer circuit 41 includes two input portions, one output portion and one selective control input portion. The protection circuit 24 and the current detection circuit 27 are connected to the input portions of the first multiplexer circuit 41. The second multiplexer circuit 42 is connected to the output portion of the first multiplexer circuit 41. The current/voltage control circuit 23 is connected to the selective control input portion of the first multiplexer circuit 41.

The first multiplexer circuit 41 generates the abnormality detection signal according to the electrical signal from the current/voltage control circuit 23, a voltage detection signal from the protection circuit 24 and a current detection signal from the current detection circuit 27. The abnormality detection signal generated by the first multiplexer circuit 41 is input to the second multiplexer circuit 42.

The second multiplexer circuit 42 includes two input portions and one output portion. The output portion of the second multiplexer circuit 42 and the enable electrode 15 are connected to the input portions of the second multiplexer circuit 42. The sense electrode 16 is connected to the output portion of the second multiplexer circuit 42.

When the MCU is connected to the enable electrode 15, and the pull-up or pull-down resistor is connected to the sense electrode 16, an on-signal is input to the enable electrode 15 from the MCU, and the abnormality detection signal is taken out from the sense electrode 16. The abnormality detection signal is converted into an electrical signal by the resistor connected to the sense electrode 16. An abnormality in the state of the semiconductor device 1 is detected based on this electrical signal.

### Problems in Mechanical Fuses

FIG. 3 is a diagram showing an example of an electronic device which includes mechanical fuses. The electronic device B of the present configuration example includes a control unit B10, a battery B20, a load B30 and a fuse box B40.

The control unit B10 receives the supply of the power supply voltage VB from the battery B20 via the fuse box B40 to drive the load B30. With reference to the figure, the control unit B10 includes a DC/DC converter B11, a microcomputer B12, an upper switch B13, a power supply electrode B14, an output electrode B15 and a reference voltage electrode B16. The control unit B10 may be, for example, an ECU [electronic control unit].

The DC/DC converter B11 generates a desired internal power supply voltage from t power supply voltage VB, and outputs the internal power supply voltage to the portions (such as the microcomputer B12) of the control unit B10.

The microcomputer B12 receives the supply of the internal power supply voltage from the DC/DC converter B11 to perform on/off control on the upper switch B13.

The upper switch B13 is connected between the power supply electrode B14 and the output electrode B15, and is subjected to the on/off control corresponding to an instruction from the microcomputer B12.

The power supply electrode B14 receives the supply of the power supply voltage VB from the battery B20 via the fuse box B40. For example, the output electrode B15 is connected to the load B30 via a wire W3. For example, the reference voltage electrode B16 is connected to the ground end.

The fuse box B40 includes n fuses B41 (1) to B41 (n), an input electrode B42 and output electrodes B43 (1) to B43 (n).

The fuse B41 (i) (where i=1, 2, . . . and n) is connected between the input electrode B42 and the output electrode B43 (i). The fuse B41 (i) is a so-called mechanical fuse, and is blown due to Joule heat when a current exceeding its rated current flows through the fuse B41 (i), with the result that the circuit is protected.

For example, the input electrode B42 is connected to the positive end (=the application end of the power supply voltage VB) of the battery B20 via a wire W1. For example, the output electrode B43 (1) is connected to the power supply electrode B14 of the control unit B10 via a wire W2.

In the electronic device B using the fuse box B40, there are two problems. The first problem is that the reaction time (=the time required for the blowing) of the fuse B41 (i) is unclear and is not accurate. Hence, damage to the control unit B10 to be protected can often be a problem. The second problem is that it is necessary to replace the fuse B 41 (i) which has been blown. In most cases, a complete system replacement (=replacement of the fuse box B40) is required.

In order to solve the problem described above, for example, it is conceivable to use an electronic fuse (so-called e-fuse) utilizing an IPD instead of the mechanical fuse. However, the control unit B10 often includes its own input capacitor in a subsystem such as the DC/DC converter B11. Hence, the control unit B10 functions as a capacitive load having a large capacitance value (in general, in an mF range) from the viewpoint of the electronic fuse.

Hence, in a general electronic fuse utilizing the IPD, it is necessary to increase the siz of an output switch so that even if a large inrush current flows when the control unit B10 is started up, an overheat protection function is not performed. Therefore, this leads to an increase in the cost of the IPD.

If a precharge circuit using discrete components is prepared, it is not necessary to increase the size of the output switch of the IPD. However, since it is necessary to increase the number of components, and to increase the size of a PCB [printed circuit board], the cost of the entire electronic device can be increased.

A novel semiconductor device which can solve the problems described above is proposed below.

### Semiconductor Device (Second Embodiment)

FIG. 4 is a diagram showing a second embodiment of the semiconductor device 1 an example of the configuration of the semiconductor device 1 which replaces the mechanical fuse). In the electronic device B of the present configuration example, based on FIG. 3 described above, the fuse box B40 is replaced with the semiconductor device 1.

The control unit B10 which is externally attached to the source electrode 12 (=output electrode OUT) of the semiconductor device 1 functions as a capacitive load having a large capacitance value from the viewpoint of the semiconductor device 1. Hence, the control unit B10 is equivalently shown as the parallel circuit of a capacitor C1 and a resistor R1. In the figure, a resistor R2 for pulling down the sense electrode 16 to the ground end is explicitly shown.

The semiconductor device 1 basically has the same configuration as in the first embodiment (FIG. 2) described previously, and further includes a CMODE enable electrode 51, an input circuit 52 and a mode control circuit 53. Hence, the constituent elements which have already been described are identified with the same symbols as in FIG. 2, thus repeated description is omitted and new constituent elements and constituent elements related thereto will be mainly described.

The power MISFET 9 is an output switch which electrically conducts or interrupts between the drain electrode 11 and the source electrode 12 according to the gate drive signal VG.

The overcurrent protection circuit 34 controls the gate drive signal VG to detect the output current IOUT flowing through the power MISFET 9 and to perform overcurrent protection.

The overheat protection circuit 36 detects a temperature to be monitored and controls t gate drive signal VG to perform overheat protection.

The temperature to be monitored may be a first temperature Temp1 which is detected in a power element formation region including the power MISFET 9. The first temperature Temp1 may be, for example, the pn junction temperature Tj1 of the power element formation region.

The temperature to be monitored may be a temperature difference ΔTemp (=Temp 1−Temp2) between the first temperature Temp1 and a second temperature Temp2 detected in a region other than the power element formation region. The second temperature Temp2 may be, for example, the pn junction temperature Tj2 of an analogue circuit formation region or a logic circuit formation region, the case temperature Tc of the semiconductor device 1 or the ambient temperature Ta around the semiconductor device 1.

The CMODE enable electrode 51 is an external electrode for switching the enabling and disabling of the mode control circuit 53.

The input circuit 52 shapes the waveform of an electrical signal applied to the CMODE enable electrode 51, and outputs the electrical signal to the mode control circuit 53.

The mode control circuit 53 generates a mode control signal S1 for switching the setting of each of the overcurrent protection circuit 34 and the overheat protection circuit 36 to a normal mode and the setting to a capacitive load drive mode. The mode control signal S1 is output to each of the overcurrent protection circuit 34 and the overheat protection circuit 36.

For example, when the electrical signal applied to the CMODE enable electrode 51 i high, the mode control circuit 53 is enabled, and is brought into a state where the logic level of the mode control signal S1 can be switched. For example, when the mode control signal S1 is high, the overcurrent protection circuit 34 and the overheat protection circuit 36 are set to the normal mode whereas when the mode control signal S1 is low, the overcurrent protection circuit 34 and the overheat protection circuit 36 are set to the capacitive load drive mode.

In the capacitive load drive mode, the overcurrent protection circuit 34 performs a current restriction operation which restricts the output current IOUT to an overcurrent protection threshold value Iocp or less. In particular, in the capacitive load drive mode, the overcurrent protection threshold value Iocp is set to a second overcurrent protection threshold value Iocp2 (for example, Iocp2=Iocp1×0.7) lower than a first overcurrent protection threshold value Iocp1 which is set in the normal mode.

Each time the temperature to be monitored (for example, the temperature difference ΔTemp described above) is increased to an overheat protection threshold value Ttsd, the overheat protection circuit 36 forcibly turns off and restarts the power MISFET 9 in a repeated manner. In particular, in the capacitive load drive mode, the overheat protection threshold value Ttsd is set to a second overheat protection threshold value Ttsd2 (for example, Ttsd 2=30 °C) lower than a first overheat protection threshold value Ttsd1 (for example, Ttsd 1=90 °C) which is set in the normal mode.

On the other hand, for example, when the electrical signal applied to the CMODE enable electrode 51 is low, the mode control circuit 53 is disabled. In this case, the mode control signal S1 is fixed to a high level. Hence, the overcurrent protection circuit 34 and the overheat protection circuit 36 are set to the normal mode.

As described above, in the electronic device B of the present configuration example, fuse box B40 described previously is replaced by the semiconductor device 1. In other words, when the output current IOUT is excessively increased (for example, several tens of amperes to 100 A), the power MISFET 9 is forcedly turned off, and thus the output current IOUT is restricted or interrupted with high speed and high accuracy. Hence, both the semiconductor device 1 and the control unit B10 can be safely protected. Unlike the configuration using mechanical fuses, even if a failure occurs, there is no need to replace the blown fuse B41 (i).

Furthermore, the semiconductor device 1 includes the capacitive load drive mode as it operation mode. Hence, it is possible to appropriately drive the capacitive load (in the figure, the control unit B10) without increasing the size of the power MISFET 9 or providing an additional external component.

In the following description, attention is focused on an abnormality protection operation performed by the semiconductor device 1, and a difference between the normal mode and the capacitive load drive mode of the semiconductor device 1 will be described. In the following description, the advantages of using the capacitive load drive mode will be made clear.

### Abnormality Protection Operation

FIG. 5 is a diagram showing a first example of the abnormality protection operation in the semiconductor device 1 of the second embodiment (FIG. 4). The figure shows, sequentially from above, the applied voltage (=input voltage), the output current IOUT and the output voltage VOUT of the input electrode IN.

The figure shows a behavior when a resistive load (or an inductive load) is driven by the semiconductor device 1 of the second embodiment (FIG. 4). In this case, when the electrical signal applied to the input electrode IN is raised high, the output voltage VOUT is raised to the power supply voltage VB. The output current IOUT reaches a target value (nominal value) without exceeding the overcurrent protection threshold value Iocp.

The behavior described above occurs regardless of whether the overcurrent protection circuit 34 and the overheat protection circuit 36 are set to the normal mode or the capacitive load drive mode. In other words, when the resistive load or the inductive load is driven by the semiconductor device 1 of the second embodiment (FIG. 4), even if the overcurrent protection circuit 34 and the overheat protection circuit 36 are set to the capacitive load drive mode, the operation of the semiconductor device 1 is not particularly affected.

On the other hand, when the capacitive load is driven by the semiconductor device 1 the second embodiment (FIG. 4), the behavior of the semiconductor device 1 differs according to whether the overcurrent protection circuit 34 and the overheat protection circuit 36 are set to the normal mode or the capacitive load drive mode.

FIG. 6 is a diagram showing a second example of the abnormality protection operation in the semiconductor device 1 of the second embodiment (FIG. 4). The figure shows, sequentially from above, the applied voltage (=input voltage), the output current IOUT and the output voltage VOUT of the input electrode IN.

The figure shows a behavior when the capacitive load (for example, the control unit B10) is driven by the semiconductor device 1 of the second embodiment (FIG. 4). In the figure, it is assumed that the electrical signal applied to the CMODE enable electrode 51 is low, and the mode control signal S1 is fixed to a high level. In other words, the figure shows the behavior when the overcurrent protection circuit 34 and the overheat protection circuit 36 are set to the normal mode.

In this case, when the electrical signal applied to the input electrode IN is raised high, a large inrush current flows through the capacitive load, and thus the output current IOUT is rapidly increased. Here, the overcurrent protection circuit 34 performs the current restriction operation such that the output current IOUT is equal to or less than the overcurrent protection threshold value Iocp (=Iocp1).

When the capacitance value of the capacitive load is high, and the element size of the power MISFET 9 is small, heat generated by the power MISFET 9 is increased. Consequently, each time the temperature to be monitored (for example, the temperature difference ΔTemp described above) is increased to the overheat protection threshold value Ttsd (=Ttsd1), the overheat protection circuit 36 is brough into a state where the overheat protection circuit 36 forcibly turns off and restarts the power MISFET 9 in a repeated manner.

A certain cooling time Tcd is needed during a period in which the power MISFET 9 restarted after the power MISFET 9 is forcibly turned off by an overheat protection operation. During the cooling time, a state where the output current IOUT is prevented from being supplied to the capacitive load continues. Hence, as shown in the figure, a problem may occur on the rise of the output voltage VOUT.

When the element size of the power MISFET 9 is increased, the overheat protection operation is unlikely to be performed, and thus the output voltage VOUT can be properly raised. However, as described previously, an increase in the size of the power MISFET 9 leads to an increase in the cost of the semiconductor device 1.

FIG. 7 is a diagram showing a third example of the abnormality protection operation in the semiconductor device 1 of the second embodiment (FIG. 4). The figure shows, sequentially from above, the applied voltage (=input voltage), the output current IOUT and the output voltage VOUT of the input electrode IN.

As with FIG. 6 described above, the figure shows a behavior when the capacitive load (for example, the control unit B10) is driven by the semiconductor device 1 of the second embodiment (FIG. 4). The figure is the same as FIG. 6 in that the overcurrent protection circuit 34 and the overheat protection circuit 36 are set to the normal mode. However, the figure differs from FIG. 6 in an overcurrent protection operation in the normal mode.

With reference to the figure, the overcurrent protection circuit 34 performs an off-latch operation to forcibly turn off the power MISFET 9 in a repeated manner when the output current IOUT is increased to the overcurrent protection threshold value Iocp (=Iocp1).

The off-latch operation as described above is extremely effective in order to comply with strict safety standards such as AEC-Q100-012 standard. However, in view of the driving of the capacitive load, it is considered that the off-latch operation is not appropriate. This is because when the power MISFET 9 is forcibly subjected to the off-latch operation, the supply of the output current IOUT to the capacitive load is fully interrupted, and thus the output voltage VOUT is not raised at all.

Hence, when the overcurrent protection circuit 34 performs the off-latch operation, increasing the size of the power MISFET 9 is not effective at all, and thus an external precharge circuit is essential.

FIG. 8 is a diagram showing a fourth example of the abnormality protection operation in the semiconductor device 1 of the second embodiment (FIG. 4). The figure shows, sequentially from above, the applied voltage (=input voltage), the output current IOUT and the output voltage VOUT of the input electrode IN.

As with FIGS. 6 and 7 described above, the figure shows a behavior when the capacitive load (for example, the control unit B10) is driven by the semiconductor device 1 of the second embodiment (FIG. 4). However, the figure differs from FIGS. 6 and 7 in that the overcurrent protection circuit 34 and the overheat protection circuit 36 are set not to the normal mode but to the capacitive load drive mode.

With reference to the figure, in the capacitive load drive mode, the overcurrent protection circuit 34 performs the current restriction operation in which the output current IOUT is restricted to the overcurrent protection threshold value Iocp (=Iocp2<Iocp1) or less. Each time the temperature to be monitored (for example, the temperature difference ΔTemp described above) is increased to the overheat protection threshold value Ttsd (=Ttsd2<Ttsd1), the overheat protection circuit 36 forcibly turns off and restarts the power MISFET 9 in a repeated manner.

As described above, in the capacitive load drive mode, in a state where both the overcurrent protection threshold value Iocp and the overheat protection threshold value Ttsd (at least the overheat protection threshold value Ttsd) are lowered relative to the normal mode, the power MISFET 9 is forcibly turned off and restarted in a repeated manner.

Hence, the cooling time Tcd during the period in which the power MISFET 9 is restarted after the power MISFET 9 is forcibly turned off by the overheat protection operation is reduced. Consequently, it is possible to charge the capacitive load and raise the output voltage VOUT without increasing the size of the power MISFET 9 or providing an additional external component.

As described above, in the capacitive load drive mode, it is possible to appropriately driv the capacitive load which is difficult to drive in the normal mode.

In the capacitive load drive mode, as described previously, the overcurrent protection threshold value Iocp and the overheat protection threshold value Ttsd are lowered relative to the normal mode. Hence, while the capacitive load is being charged, the semiconductor device 1 and the capacitive load (for example, the control unit B10) connected thereto are maintained in a safety operation area (so-called SOA).

In the capacitive load drive mode, at least one of the second overcurrent protection threshold value Iocp2 and the second overheat protection threshold value Ttsd2 may be stepwise lowered to the first overcurrent protection threshold value Iocp1 and the first overheat protection threshold value Ttsd1 as the output voltage VOUT is increased or as time passes.

When a predetermined return condition (details of which will be described later) is satisfied, the mode control circuit 53 may switch the overcurrent protection circuit 34 and the overheat protection circuit 36 from the capacitive load drive mode to the normal mode (see “CMODE EXIT” in the Figure).

For example, as in the capacitive load drive mode, the overcurrent protection operation after returning to the normal mode may be the current restriction operation in which the output current IOUT is restricted to the overcurrent protection threshold value Iocp (=Iocp1) or less.

For example, the overcurrent protection operation after returning to the normal mode may be a hiccup operation in which each time the output current IOUT is increased to the overcurrent protection threshold value Iocp (=Iocp1), the power MISFET 9 is forcibly turned off and restarted in a repeated manner. In the hiccup operation as described above, heat generated by the power MISFET 9 is suppressed as compared with the current restriction operation described above.

For example, the overcurrent protection operation after returning to the normal mode may be the off-latch operation which continues to forcibly turn off the power MISFET 9 when the output current IOUT is increased to the overcurrent protection threshold value Iocp (=Iocp1). In the off-latch operation as described above, safety when an overcurrent occurs is further enhanced as compared with the current restriction operation and the hiccup operation described above.

As described above, in the semiconductor device 1 of the present configuration example, the normal mode and the capacitive load drive mode are switched as necessary. Hence, for example, the semiconductor device 1 is also compatible with process technology in which the on-resistance of the power MISFET 9 is relatively high, and a stricter overcurrent protection operation is required.

When the operation and architecture of the capacitive load drive mode described above are summarized, the most important attributes are as follows.

(1) In the capacitive load drive mode, an overheat detection/restart operation (=a state where the power MISFET 9 is forcibly turned off by overheat detection and restarted by overheat release in a repeated manner) is forced as the overheat protection operation. In this way, the capacitive load is repeatedly charged until the output voltage VOUT is sufficiently raised.

(2) In the capacitive load drive mode, the current restriction operation is forced as the overcurrent protection operation. In this way, it is possible to prevent the output current IOUT from being subjected to the off-latch operation before the capacitive load is fully charged.

(3) In the capacitive load drive mode, the overcurrent protection threshold value Iocp i lowered (Iocp1→Iocp2). In this way, the peak of an inrush current which flows through the capacitive load being charged is reduced. For example, the second overcurrent protection threshold value Iocp2 set in the capacitive load drive mode may be 70% of the first overcurrent protection threshold value Iocp1 set in the normal mode (that is, Iocp 2=Iocp1×0.7). However, the ratio described above is not limited at all.

(4) In the capacitive load drive mode, the overheat protection threshold value Ttsd is lowered (Ttsd1×Ttsd2). This has two effects. The first effect is that the semiconductor device 1 is maintained in the safety operation area while the capacitive load is not fully charged, that is, while the capacitive load is functioning as a virtual short circuit. The second effect is that since the semiconductor device 1 is rapidly cooled to an overheat release temperature (safe temperature), the timing of the restart of the power MISFET 9 is accelerated, and thus the capacitive load can continue to be charged. In other words, a charge pump effect is obtained, and thus it is possible to reliably raise the output voltage VOUT.

(5) When the output voltage VOUT exceeds a predetermined threshold voltage Vth, t capacitive load drive mode is automatically returned to the normal mode. In other words, the threshold voltage Vth described above corresponds to a threshold value for completion of the capacitive load drive mode. As described above, the overcurrent protection operation after returning to the normal mode may be any one of the current restriction operation, the hiccup operation and the off-latch operation.

(6) When a predetermined time (for example, 50 ms) has elapsed since the setting the capacitive load drive mode, the capacitive load drive mode may be automatically returned to the normal mode. In this way, even if an output short circuit or another failure occurs, the semiconductor device 1 can be maintained in the safety operation area.

(7) The semiconductor device 1 includes the CMODE enable electrode 51 for switching the enabling and disabling of the mode control circuit 53 (and hence the capacitive load drive mode). In this way, a user can arbitrarily determine whether the capacitive load drive mode is utilized. Furthermore, it is possible to easily switch the enabling and disabling of the mode control circuit 53 without applying a special gimmick (such as high-frequency PWM [pulse width modulation] drive or inputs at a plurality of levels) to the input electrode IN.

Startup Operation FIG. 9 is a diagram showing a first example of a startup operation in the semiconductor device 1 of the second embodiment (FIG. 4). The figure shows, sequentially from above, the output current IOUT, the output voltage VOUT and the mode control signal S1.

The figure shows a behavior when a purely resistive load (for example, R1=2Ω, C1 F) is driven by the semiconductor device 1 of the second embodiment (FIG. 4). The on-resistance of the power MISFET 9 is assumed to be 4 mΩ.

As shown in the figure, the mode control circuit 53 drops the mode control signal S1 low when the power MISFET 9 is turned on. Hence, the overcurrent protection circuit 34 and the overheat protection circuit 36 are set to the capacitive load drive mode described above. The capacitive load drive mode does not affect the operation of driving the resistive load (for example, a slew rate) at all.

When the predetermined return condition is satisfied, the mode control circuit 53 raises the mode control signal S1 high. In this way, the overcurrent protection circuit 34 and the overheat protection circuit 36 are switched from the capacitive load drive mode to the normal mode.

With reference to the figure, as the return condition described above, it is detected t the output voltage VOUT exceeds the predetermined threshold voltage Vth. For example, the threshold voltage Vth may be set to a voltage value (Vth=VB−Vx) which is lower than the power supply voltage VB (for example, 14 V) by a bias voltage Vx (for example, 2 V). In the setting as described above, the capacitive load drive mode is automatically completed when the output voltage VOUT is fully raised.

As the return condition described above, it may be detected that a predetermined time (for example, 50 ms) has elapsed after the mode control signal S1 was raised low.

FIG. 10 is a diagram showing a second example of the startup operation in the semiconductor device 1 of the second embodiment (FIG. 4). As with FIG. 9 described above, the figure shows, sequentially from above, the output current IOUT, the output voltage VOUT and the mode control signal S1.

The figure shows a behavior when the capacitive load (for example, R1=2Ω, C1=1 mF) is driven by the semiconductor device 1 of the second embodiment (FIG. 4). The on-resistance of the power MISFET 9 is assumed to be 4 mΩ.

As shown in the figure, when the power MISFET 9 is turned on, the mode control signal S1 is dropped low, and the overcurrent protection circuit 34 and the overheat protection circuit 36 are set to the capacitive load drive mode. In this way, the output voltage VOUT is increased to the threshold voltage Vth for a startup time t1 (for example, less than 2 ms) in a required range. The return condition (output voltage monitoring or timer monitoring) from the capacitive load drive mode to the normal mode is the same as described above.

FIG. 11 is a diagram showing a third example of the startup operation in the semiconductor device 1 of the second embodiment (FIG. 4). As with FIGS. 9 and 10 described above, the figure shows, sequentially from above, the output current IOUT, the output voltage VOUT and the mode control signal S1.

The figure shows a behavior when a capacitive load (for example, R1=2Ω, C1=4 mF) which has a larger capacitance than in FIG. 10 is driven by the semiconductor device 1 of the second embodiment (FIG. 4). The on-resistance of the power MISFET 9 is assumed to be 4 mΩ.

As shown in the figure, when the power MISFET 9 is turned on, the mode control signal S1 is dropped low, and the overcurrent protection circuit 34 and the overheat protection circuit 36 are set to the capacitive load drive mode. In this way, the output voltage VOUT is increased to the threshold voltage Vth for a startup time t2 (for example, less than 7.5 ms) in a required range. The return condition (output voltage monitoring or timer monitoring) from the capacitive load drive mode to the normal mode is the same as described above.

Semiconductor Device (Third Embodiment) FIG. 12 is a diagram showing a third embodiment of the semiconductor device 1 (=corresponding to a comparative example to be contrasted with a fourth embodiment which will be described later). The semiconductor device 1 of the present embodiment is based on the second embodiment (FIG. 4) described above and further includes a high-speed turn-off circuit 60.

The figure explicitly shows, as constituent elements of the drive signal output circuit 40, a transistor M1 (for example, a P-channel MISFET), a transistor M2 (for example, an N-channel MISFET) and current sources CS1 and CS2.

The figure shows the resistance component R11 and the inductance component L11 of a wire harness between the application end of the power supply voltage VB and the drain of the power MISFET 9. The figure also shows the resistance component R12 and the inductance component L12 of the wire harness between the source of the power MISFET 9 and a reference potential end (for example, the ground end).

When the gate drive signal VG is switched high (=logic level in an on state), the current source CS1 (=corresponding to a first current source) generates a first current I1 for charging the gate capacitance (not shown) of the power MISFET 9.

When the gate drive signal VG is switched low (=logic level in an off state), the current source CS2 (=corresponding to a second current source) generates a second current I2 for discharging the gate capacitance (not shown) of the power MISFET 9.

The source of the transistor M1 is connected via the current source CS1 to the application end of the step-up voltage VCP. The source of the transistor M2 is connected via the current source CS2 to the application end of the output voltage VOUT. The drains of the transistors M1 and M2 are connected to the gate of the power MISFET 9 (=the application end of the gate drive signal VG). The gate of the transistor M1 is connected to the application end of a gate voltage GM1. The gate of the transistor M2 is connected to the application end of a gate voltage GM2. The gate voltages GM1 and GM2 can be understood to be supplied from the current/voltage control circuit 23.

The transistors M1 and M2 connected as described above form the half-bridge output stage of the drive signal output circuit 40. With reference to the figure, the transistor M1 electrically conducts or interrupts between the current source CS1 and the gate of the power MISFET 9 according to the gate voltage GM1. The transistor M2 electrically conducts or interrupts between the gate of the power MISFET 9 and the current source CS2 according to the gate voltage GM2.

For example, when the electrical signal (input signal) applied to the input electrode is high (=logic level when the power MISFET 9 is turned on), the gate voltages GM1 and GM2 are set low. Hence, the transistor M1 is in an on state, and the transistor M2 is in an off state. Here, the gate capacitance (not shown) of the power MISFET 9 is charged by the first current I1 flowing from the application end of the step-up voltage VCP via the current source CS1 and the transistor M1 to the gate of the power MISFET 9. Therefore, the gate drive signal VG is switched high (∞VCP). Consequently, the power MISFET 9 is turned on.

For example, when the electrical signal (input signal) applied to the input electrode is low (=logic level when the power MISFET 9 is turned off), the gate voltages GM1 and GM2 are set high. Hence, the transistor M1 is in an off state, and the transistor M2 is in an on state. Here, the gate capacitance (not shown) of the power MISFET 9 is discharged by the second current I2 flowing from the gate of the power MISFET 9 via the transistor M2 and the current source CS2 to the application end of the output voltage VOUT. Therefore, the gate drive signal VG is switched low (∞VOUT). Consequently, the power MISFET 9 is turned off.

As described above, the transistors M1 and M2 are complementarily turned on and off according to the electrical signal (input signal) applied to the input electrode 13 and hence the gate voltages GM1 and GM2.

The high-speed turn-off circuit 60 rapidly turns on and off the power MISFET 9 according to an abnormality detection signal DET (for example, an overcurrent protection signal or an overheat protection signal) by a second gate discharge capability higher than the first gate discharge capability of the drive signal output circuit 40.

With reference to the figure, the high-speed turn-off circuit 60 includes a transistor M3 (for example, an N-channel MISFET). The drain of the transistor M3 is connected to the gate of the power MISFET 9. The source of the transistor M3 is connected to the source of the power MISFET 9 (=the application end of the output voltage VOUT). The gate of the transistor M3 is connected to the application end of the abnormality detection signal DET.

The transistor M3 connected as described above electrically conducts or interrupts between the gate and source of the power MISFET 9 according to the abnormality detection signal DET.

For example, when the abnormality detection signal DET is high (=logic level when abnormality is detected), the transistor M3 is in an on state. Hence, the gate discharge path of the drive signal output circuit 40 (=the transistor M2 and the current source CS2 connected in series between the gate and source of the power MISFET 9) is bypassed by the transistor M3.

Consequently, the gate drive signal VG is lowered via the transistor M3 to a low level (∞VOUT) without depending on the drive signal output circuit 40 and without delay. Hence, as compared with a case where the power MISFET 9 is normally turned off using the drive signal output circuit 40, the power MISFET 9 is rapidly turned off in a shorter time.

On the other hand, when the abnormality detection signal DET is low (=logic level wh no abnormality is detected), the transistor M3 is in an off state. Hence, there is no problem in the control of the charge and discharge of the gate drive signal VG using the drive signal output circuit 40.

FIG. 13 is a diagram showing the turn-off behavior of the semiconductor device 1 the third embodiment (FIG. 12). A solid line represents the drain-source voltage Vds of the power MISFET 9. A small dashed line represents the output current IOUT flowing through the power MISFET 9. A large dashed line represents the power consumption Pc (=IOUT×Vds) of the power MISFET 9.

For example, when a ground fault occurs in the source electrode 12 (=output electrode OUT), the power MISFET 9 is forcibly turned off by the abnormality protection operation (for example, the overcurrent protection operation or the overheat protection operation). When the power MISFET 9 is forcibly turned off, and thus the drain-source voltage Vds of the power MISFET 9 reaches a predetermined maximum peak value (=active clamp voltage Vclp), the active clamp circuit 26 is operated to return the power MISFET 9 to an on state (strictly speaking, a state where the power MISFET 9 is not fully turned off).

The power MISFET 9 is maintained in an on state until inductive energy stored in the inductance component of a load short-circuit path is dissipated (which may be understood as regeneration, absorption or consumption). Here, the semiconductor device 1 needs to bring the power MISFET 9 into an off state, and then return to an on state again such that the power MISFET 9 is turned off, and thus the inductive energy (=total energy which needs to be safely dissipated) stored in the inductance component of the load short-circuit path is minimized. The semiconductor device 1 needs to control the turning off of the power MISFET 9 such that an instantaneous maximum bonding temperature does not exceed the absolute maximum rating.

In the semiconductor device 1 of the present embodiment, the power MISFET 9 is rapidly turned off, and thus the maximum peak value of the power consumption Pc is relatively increased. However, when the maximum value of the drain-source voltage Vds (=active clamp voltage Vclp) is the same, a clamp time tclp (=degaussing time) required to completely dissipate all the inductive energy stored in the inductance component of the load short-circuit path is reduced according to Faraday's law.

Hence, the total power consumption amount (total energy) which needs to be safely dissipated by an active clamp operation is decreased. Consequently, the maximum bonding portion temperature of the power MISFET 9 is lowered. As described above, the high-speed turn-off circuit 60 is introduced, and thus it is possible to enhance harness ground fault resistance.

### Startup Failure Caused by High-Speed Turning Off

FIG. 14 is a diagram showing the startup behavior of the semiconductor device 1 in the third embodiment (FIG. 12). FIG. 15 is an enlarged view of a part of FIG. 14 (frame α indicated by alternate long and short dashed lines). Each of the figures shows, sequentially from above, the power supply voltage VB, the output voltage VOUT and the output current IOUT.

At time t11, the semiconductor device 1 is started up in the capacitive load drive mode. As described previously, in the capacitive load drive mode, in a state where the output current IOUT is restricted to the overcurrent protection threshold value Iocp (=Iocp2 <Iocp1) or less, each time the temperature to be monitored (for example, the temperature difference ΔTemp described above) is increased to the overheat protection threshold value Ttsd (=Ttsd2<Ttsd1), the power MISFET 9 is forcibly turned off and restarted in a repeated manner.

Here, if the high-speed turning off described above is performed when the power MISFET 9 is forcibly turned off, overshoot and undershoot of the output voltage VOUT occur. If the output current IOUT is rapidly increased when the power MISFET 9 is restarted, the power supply voltage VB may be lowered transiently.

When the output voltage VOUT exceeds the threshold voltage Vth (=VB−Vx) due to the behavior described above at time t12, the capacitive load drive mode is returned to the normal mode at an earlier timing than normal. Here, the overcurrent protection operation is switched to the hiccup operation described previously. Hence, depending on the load to be driven, the output voltage VOUT is not raised to the desired value (≈the power supply voltage VB).

When in particular, the wire harness is connected to the drain electrode 11 (=power supply voltage VBB) and the source electrode 12 (=output voltage OUT), the drain-source voltage Vds of the power MISFET 9 is easily lowered. Hence, the timing at which the capacitive load drive mode is switched to the normal mode is accelerated, and thus a startup failure in the capacitive load may occur.

In the following description, in view of the consideration described above, the fourth embodiment which can remove the startup failure in the capacitive load is proposed.

Semiconductor Device (Fourth Embodiment) FIG. 16 is a diagram showing the fourth embodiment of the semiconductor device

In the semiconductor device 1 of the present embodiment, the overcurrent protection circuit 34 detects the output current IOUT flowing through the power MISFET 9 (=corresponding to the output switch) to perform overcurrent protection.

With reference to the figure, the overcurrent protection circuit 34 includes a detection circuit 341, a control circuit 342 and an output circuit 343 as constituent elements for performing the overcurrent protection operation after the completion of the capacitive load drive mode, and more specifically, forcible turn-off control on the power MISFET 9 including the hiccup operation described previously.

For example, after the mode control signal S1 output from the mode control circuit 53 dropped from high to low, the detection circuit 341 outputs an internal signal S11 corresponding to the result of comparison between the output current IOUT and an overcurrent protection threshold value IocpH. The detection circuit 341 may receive an input of a sense voltage Vs (∝IOUT) corresponding to the output current IOUT.

When an instruction to turn on the power MISFET 9 is provided, for example, when the input electrode 13 (=input electrode IN) is switched high, the mode control circuit 53 may raise the mode control signal S1 high. On the other hand, when the drain-source voltage Vds of the power MISFET 9 falls below a detection threshold value Vx (=bias voltage Vx described previously), the mode control circuit 53 may drop the mode control signal S1 low.

In other words, in the semiconductor device 1 of the present embodiment, the mode control signal S1 is switched high in the capacitive load drive mode described above, and is switched low after the completion of the capacitive load drive mode. As described above, the logic level of the mode control signal S1 may be opposite to that illustrated in the second embodiment (FIGS. 9 to 11).

For example, when the output current IOUT is greater than the overcurrent protection threshold value IocpH, the internal signal S11 is high. On the other hand, when the output current IOUT is less than the overcurrent protection threshold value IocpH, the internal signal S11 is low. However, when the mode control signal S1 is high, the internal signal S11 is fixed (masked) to a low level.

The overcurrent protection threshold value IocpH is preferably set to a value (for example, 90 A) which is greater than an overcurrent protection threshold value IocpL (for example, 60 A) set in the capacitive load drive mode. The overcurrent protection threshold value IocpH may have hysteresis.

The control circuit 342 receives inputs of the mode control signal S1 and a count completion signal S2 output from the mode control circuit 53 and an input of the internal signal S11 output from the detection circuit 341, and outputs an internal signal S12. The internal configuration and the operation of the control circuit 342 will be described later.

FIG. 17 is a diagram showing an example of generation of the count completion signal S2. The figure shows terminal voltages (IN/CMODE) for the input electrode 13 and the CMODE enable electrode 51, the mode control signal S1 and the count completion signal S2.

When at time t31, the high-level terminal voltages (IN/CMODE) are applied to the input electrode 13 and the CMODE enable electrode 51, the mode control signal S1 is raised high. Hence, the semiconductor device 1 is changed to the capacitive load drive mode.

At time t31, the mode control circuit 53 starts to count a time T1 (for example, 50 As a means for measuring the time T1, a CR timer or the like may be used.

When at time t32, the counting of the time T1 is completed, the mode control signal S1 is dropped low. In other words, the capacitive load drive mode is completed not only when the drain-source voltage Vds of the power MISFET 9 falls below the detection threshold value Vx but also when the time T1 has elapsed. In this case, the semiconductor device 1 transitions from the capacitive load drive mode to the normal mode without passing through an intermediate mode (details of which will be described later).

In the count completion signal S2, a pulse is generated when the time T1 has elapsed after provision of the instruction to turn on the power MISFET 9.

With reference back to FIG. 16, the main portions of the overcurrent protection circuit 34 will be described again. The output circuit 343 receives inputs of the internal signals S11 and S12 to output a forcible-off signal S34 for the power MISFET 9.

For example, when the internal signal S11 is high, the forcible-off signal S34 is low whereas when the internal signal S11 is low, the forcible-off signal S34 is high. The forcible-off signal S34 is kept low for a time T2 (for example, 50 ms) after the generation of the pulse in the internal signal S12.

For example, when the forcible-off signal S34 is low, the drive signal output circuit 40 forcibly turns off the power MISFET 9. On the other hand, for example, when the forcible-off signal S34 is high, the drive signal output circuit 40 releases the forcibly turning off of the power MISFET 9.

The overcurrent protection circuit 34 also includes constituent elements for performing the overcurrent protection operation in the capacitive load drive mode, and more specifically, the current restriction operation which lowers the gate drive signal VG of the power MISFET 9 to restrict the output current IOUT to the overcurrent protection threshold value Iocp or less though the constituent elements are not explicitly shown in the figure.

FIG. 18 is a diagram showing an example of the configuration of the control circuit 342. The control circuit 342 of the present configuration example includes a logical product operation unit AND, D flip-flops FF1 to FF4, inverters INV1 to INV3, a multiplexer MUX, and a NOR operation unit NOR.

For example, when the internal signal S11 input to a clock end (>) is raised high, t D flip-flop FF1 latches an inverted output signal XQ1 input to a data end (D), and outputs the inverted output signal XQ1 from an output end (Q) as an output signal Q1. For example, when a reset signal RST input to a reset end (O) is dropped low, the D flip-flop FF1 resets the output signal Q1 low.

For example, when the inverted output signal XQ1 input to the clock end (>) is raised high, the D flip-flop FF2 latches an inverted output signal XQ2 input to the data end (D), and outputs the inverted output signal XQ2 from the output end (Q) as an output signal Q2. For example, when the reset signal RST input to the reset end (O) is dropped low, the D flip-flop FF2 resets the output signal Q2 low.

For example, when the inverted output signal XQ2 input to the clock end (>) is raised high, the D flip-flop FF3 latches an inverted output signal XQ3 input to the data end (D), and outputs the inverted output signal XQ3 from the output end (Q) as an output signal Q3. For example, when the reset signal RST input to the reset end (O) is dropped low, the D flip-flop FF3 resets the output signal Q2 low.

For example, when the mode control signal S1 input to the clock end (>) is raised h the D flip-flop FF4 latches a high-level signal VH input to the data end (D), and outputs the high-level signal VH from the output end (Q) as an output signal Q4. For example, when an intermediate mode completion signal S22 input to the reset end (O) is dropped low, the D flip-flop FF4 resets the output signal Q4 low.

The inverter INV1 inverts the logic level of the output signal Q1 to generate the inverted output signal XQ1.

The inverter INV2 inverts the logic level of the output signal Q2 to generate the inverted output signal XQ2.

The inverter INV3 inverts the logic level of the output signal Q3 to generate the inverted output signal XQ3.

The logical product operation unit AND performs a logical product operation on each of the output signals Q1 to Q3 to generate an upper limit count reaching signal S21. The upper limit count reaching signal S21 is high when each of the output signals Q1 to Q3 is high. The upper limit count reaching signal S21 is low when at least one of the output signals Q1 to Q3 are low.

Among the constituent elements described above, the D flip-flops FF1 to FF3 and the inverters INV1 to INV3 in n stages (where n is an integer of 1 or more, for example, n=3 in the figure), and the logical product operation unit AND form a counter CNT which generates a pulse in the upper limit count reaching signal S21 when the number of times a pulse is generated in the internal signal S11 reaches an upper limit value 2ⁿ−1 (in the figure, 7 times).

The NOR operation unit NOR performs a NOR operation on the count completion signal S2 and the upper limit count reaching signal S21 to generate the intermediate mode completion signal S22. When at least one of the count completion signal S2 and the upper limit count reaching signal S21 are high, the intermediate mode completion signal S22 is low. When both the count completion signal S2 and the upper limit count reaching signal S21 are low, the intermediate mode completion signal S22 is high.

The multiplexer MUX selects and outputs, as the internal signal S12, at least one of the output signal Q1 and the upper limit count reaching signal S21 according to the output signal Q4. The output signal Q1 can be understood as a signal synchronized with the internal signal S11. However, instead of the output signal Q1, the internal signal S11 itself may be input to the multiplexer MUX.

With reference to the figure, when the output signal Q4 is high, the multiplexer MUX selects and outputs the upper limit count reaching signal S21 as the internal signal S12. The output signal Q4 is kept high until either of two time points arrives earlier: one of the two time points is a time point at which the time T1 has elapsed after the mode control signal S1 was raised high as an instruction to turn on the power MISFET 9, and the count completion signal S2 is raised high; and the other of the two time points is a time point at which the number of times the pulse is generated in the internal signal S11 reaches the upper limit, and thus the pulse is generated in the upper limit count reaching signal S21.

On the other hand, when the output signal Q4 is low, the multiplexer MUX selects and outputs the output signal Q1 as the internal signal S12. The output signal Q4 is reset low when either of two time points arrives earlier: one of the two time points is a time point at which the time T1 has elapsed after the mode control signal S1 was raised high as the instruction to turn on the power MISFET 9, and the count completion signal S2 is raised high; and the other of the two time points is a time point at which the number of times the pulse is generated in the internal signal S11 reaches the upper limit, and thus the pulse is generated in the upper limit count reaching signal S21.

FIG. 19 is a diagram showing an example of generation of the upper limit count reaching signal S21 caused by the counter CNT. The figure shows, sequentially from above, the internal signal S11, the output signals Q1 to Q3 and the upper limit count reaching signal S21.

When at t41, the first pulse is generated in the internal signal S11, the output signal Q1raised high. On the other hand, the output signals Q2 and Q3 are kept low. Hence, the upper limit count reaching signal S21 is low.

When at t42, the second pulse is generated in the internal signal S11, the output signal Q2 is raised high. On the other hand, the output signal Q2 is dropped low, and the output signal Q3 is kept low. Hence, the upper limit count reaching signal S21 is low.

When at t43, the third pulse is generated in the internal signal S11, the output signal Q is raised high again. Here, although the output signal Q2 is kept high, the output signal Q3 is kept low. Hence, the upper limit count reaching signal S21 is low.

When at t44, the fourth pulse is generated in the internal signal S11, the output signal Q3 is raised high. On the other hand, the output signals Q1 and Q2 are dropped low. Hence, the upper limit count reaching signal S21 is low.

When at t45, the fifth pulse is generated in the internal signal S11, the output signal Q is raised high again. Here, although the output signal Q3 is kept high, the output signal Q2 is kept low. Hence, the upper limit count reaching signal S21 is low.

When at t46, the sixth pulse is generated in the internal signal S11, the output signal Q is raised high again. Here, although the output signal Q3 is kept high, the output signal Q1 is dropped low. Hence, the upper limit count reaching signal S21 is low.

When at t47, the seventh pulse is generated in the internal signal S11, the output signal Q1 is raised high again. Here, the output signals Q2 and Q3 are kept high. Hence, the upper limit count reaching signal S21 is raised high.

As described above, when the number of times the pulse is generated in the internal signal S11 reaches the upper limit count (7 times), the pulse is generated in the upper limit count reaching signal S21. The number of D flip-flops in the counter CNT is increased or decreased, and thus it is possible to arbitrarily adjust the upper limit count described above.

FIG. 20 is a diagram showing an example of a mode transition in the fourth embodiment. The figure shows, sequentially from above, the mode control signal S1, the internal signals S11 and S12, the forcible-off signal S34 and the state of operation modes. The figure shows the capacitive load drive mode (CMODE), the intermediate mode (MID) and the normal mode (NORMAL) as the operation modes.

Before time t51, the mode control signal S1 is set high. Hence, the semiconductor device 1 is in the capacitive load drive mode (CMODE). The mode control signal S1 is kept high until either of two time points arrives earlier: one of the two time points is a time point at which the time T1 has elapsed after provision of the instruction to turn on the power MISFET 9; and the other of the two time points is a time point at which the drain-source voltage Vds of the power MISFET 9 falls below the detection threshold value Vx.

In the capacitive load drive mode (S1=H) described above, the overcurrent protection circuit 34 restricts the output current IOUT to the overcurrent protection threshold value IocpL (for example, 60 A) or less. The overheat protection circuit 36 forcibly turns off the power MISFET 9 when the temperature to be monitored (for example, the temperature difference ΔTemp described above) exceeds an overheat protection threshold value TtsdL (for example, 30 °C). On the other hand, the overheat protection circuit 36 releases the forcibly turning off of the power MISFET 9 when the temperature to be monitored falls below the overheat protection threshold value TtsdL. As described above, the overcurrent protection operation and the overheat protection operation in the capacitive load drive mode (S1=H) are the same as described above.

In the capacitive load drive mode (S1=H), the internal signal S11 is fixed to a low level. Hence, the internal signal S12 remains low. Consequently, the forcible-off signal S34 is kept high.

Before the time T1 has elapsed (S2=L) after provision of the instruction to turn the power MISFET 9, the drain-source voltage Vds of the power MISFET 9 falls below the detection threshold value Vx, and consequently, at time t51, the mode control signal S1 is dropped low. Thereafter, the semiconductor device 1 is kept in the intermediate mode (MID) until either of two time points arrives earlier: one of the two time points is a time point at which the time T1 has elapsed; and the other of the two time points is a time point at which the number of times the pulse is generated in the internal signal S11 reaches the upper limit (in the figure, 4 times).

The time point at which the time T1 has elapsed may be replaced by the time point at which the count completion signal S2 is raised high. The time point at which the number of times the pulse is generated in the internal signal S11 reaches the upper limit may be replaced by the time point at which the pulse is generated in the upper limit count reaching signal S21.

At time t51, the capacitive load drive mode (S1 =L) is released, and thus the overcurrent protection threshold value Iocp and the overheat protection threshold value Ttsd are increased (for example, 60 A→90 A, 30 °C→60 ° C). The output slew rate SR of the gate drive signal VG may be increased (for example, 1.5 A/μs→7 A /μs).

When at time t51, the output current IOUT exceeds the overcurrent protection threshold value IocpH (for example, 90 A), the first pulse is generated in the internal signal S11. Consequently, the forcible-off signal S34 is dropped low. Hence, the power MISFET 9 is forcibly turned off, and thus the output current IOUT is interrupted.

However, at this time point, the number of times the pulse is generated in the internal signal S11 does not reach the upper limit count (4 times). Hence, even if the pulse is generated in the internal signal S11, the internal signal S12 is kept low. Therefore, the forcible-off signal S34 is prevented from being kept low for the time T2 (for example, 50 ms). In other words, the normal hiccup operation triggered by the internal signal S12 is not performed.

When at time t51, the output current IOUT is interrupted, the output current IOUT fa below the overcurrent protection threshold value IocpH, and thus the internal signal S11 is dropped low. Consequently, the forcible-off signal S34 is raised high, and thus the forcibly turning off of the power MISFET 9 is released.

At times t52 and t53, the second and third pulses are respectively generated in the internal signal S11 each time the output current IOUT exceeds the overcurrent protection threshold value IocpH. However, the number of times the pulse is generated in the internal signal S11 has not yet reached the upper limit count (4 times). Hence, as at time t51, the normal hiccup operation is not performed, and thus the power MISFET 9 is forcibly turned off and released in a repeated manner according t o the result of comparison between the output current IOUT and the overcurrent protection threshold value IocpH.

Thereafter, when at time t54, the number of times the pulse is generated in the internal signal S11 reaches the upper limit count (4 times), the upper limit count reaching signal S21 (and hence the internal signal S12) is raised high. Therefore, the forcible-off signal S34 is kept low for the time T2. That is, the hiccup operation triggered by the internal signal S12 is performed. In other words, after time t54, the semiconductor device 1 is in the normal mode (NORMAL).

When at time t55, the time T2 has elapsed, the forcible-off signal S34 is raised high, and thus the forcibly turning off of the power MISFET 9 is released. Consequently, the output current IOUT start to flow again.

When at time t56, the output current IOUT exceeds the overcurrent protection threshold value IocpH, the internal signal S11 is raised high. After time t55 described above, the multiplexer MUX is in a state where the multiplexer MUX selects and outputs the output signal Q1 (or the internal signal S11) as the internal signal S12. Hence, when the internal signal S11 is raised high, the internal signal S12 is raised high without delay. Consequently, the forcible-off signal S34 is kept low for the time T2 again. In other words, the normal hiccup operation triggered by the internal signal S12 is continued.

In the intermediate mode (MID) described above, intervals (times t51 to t52, times t52 to t53 and times t53 to t54) during which the power MISFET 9 is forcibly turned off and released in a repeated manner are lengths (on the order of microseconds) corresponding to the response speed of the detection circuit 341. When the lengths are determined according to the response speed of the detection circuit 341, an on/off cycle may be excessively short. In such a case, a delay on the order of microseconds may be provided.

As described above, in the intermediate mode (MID), as compared with the hiccup operation in the normal mode (NORMAL), the power MISFET 9 is forcibly turned off and released at shorter intervals. Hence, even if the capacitive load drive mode (CMODE) is completed without the output voltage VOUT being sufficiently increased, the capacitive load can be charged without any problems.

After the capacitive load drive mode is completed at time t51, the overheat protection circuit 36 forcibly turns off the power MISFET 9 when the temperature to be monitored exceeds an overheat protection threshold value TtsdH (for example, 60 °C). On the other hand, the overheat protection circuit 36 releases the forcibly turning off of the power MISFET 9 when the temperature to be monitored falls below the overheat protection threshold value TtsdH. As described above, the overheat protection operation after the completion of the capacitive load drive mode (S1=L) is the same as described above. The timing at which the overheat protection threshold value Ttsd is switched may be the timing at which the normal mode (NORMAL) is started instead of the timing at which the intermediate mode (MID) is started. In the latter case, safety is enhanced. However, a capability for driving the load may be lowered.

Hence, in the intermediate mode (MID), the intervals (times t51 to t52, times t52 to t53 and times t53 to t54) during which the power MISFET 9 is forcibly turned off and released in a repeated manner may be lengths corresponding to the response speed of the overheat protection circuit 36 though such a case is not explicitly shown in the figure. However, even when the intervals during which the power MISFET 9 is forcibly turned off and released in a repeated manner depend on the response speed of either of the detection circuit 341 and the overheat protection circuit 36, the intervals are sufficiently short lengths (on the order of microseconds) as compared with the time T2 (for example, 50 ms) described above.

The figure shows an example where the capacitive load drive mode (CMODE) is completed at time t51, and thereafter, the number of times the pulse is generated in the internal signal S11 at time t54 reaches the upper limit count (four times), and thus the intermediate mode (MID) transitions to the normal mode (NORMAL).

However, when the time T1 has elapsed after provision of the instruction to turn on the power MISFET 9, even before the number of times the pulse is generated in the internal signal S11 reaches the upper limit count, the intermediate mode (MID) transitions to the normal mode (NORMAL).

FIG. 21 is a diagram showing a first example of a startup operation in the fourth embodiment. The figure shows, sequentially from above, the output voltage VOUT, the mode control signal S1, an overheat protection signal TSD and the output current IOUT.

The overheat protection signal TSD is switched high when the temperature to be monitored is greater than the overheat protection threshold value. On the other hand, the overheat protection signal TSD is switched low when the temperature to be monitored is lower than the overheat protection threshold value. When the overheat protection signal TSD is high, the power MISFET 9 is forcibly turned off. When the overheat protection signal TSD is low, the forcibly turning off of the power MISFET 9 is released.

Simulation conditions in the figure are that the inductance value Lwire of the wire harness =0.1 μH, the resistance value Rwire of the wire harness=0.2 mΩ, the power supply voltage VB=14 V and the ambient temperature Ta=25 °C

Under the simulation conditions described above, in times t61 to t62, the semiconductor device 1 is in the capacitive load drive mode (S1=H). During this period of time, the capacitive load is sufficiently charged, and thus the output voltage VOUT is increased to around the power supply voltage VB. Hence, in the figure, after time t62, neither the overcurrent protection operation nor the overheat protection operation is performed. Therefore, pulse driving in the intermediate mode (MID) described above is also not performed.

FIG. 22 is a diagram showing a second example of the startup operation in the fourth embodiment. As with FIG. 21 described above, the figure shows, sequentially from above, the output voltage VOUT, the mode control signal S1, the overheat protection signal TSD and the output current IOUT.

Simulation conditions in the figure are that the inductance value Lwire of the wire harness=1 μH, the resistance value Rwire of the wire harness=2 mΩ, the power supply voltage VB=14 V and the ambient temperature Ta=25 °C. Specifically, each of the inductance value Lwire and the resistance value Rwire of the wire harness is set to 10 times the value in FIG. 21 described above.

Under the simulation conditions described above, in times t71 to t72, the semiconductor device 1 is in the capacitive load drive mode (S1=H). However, at time t72, the capacitive load drive mode is completed before the output voltage VOUT is sufficiently increased. Consequently, in the figure, after time t72, in the intermediate mode described above, the overcurrent protection operation and the overheat protection operation are performed twice (see circles for output current IOUT). Here, at shorter intervals than in the normal hiccup operation, the power MISFET 9 is forcibly turned off and released in a repeated manner. Hence, after time t72, the output voltage VOUT is increased to around the power supply voltage VB.

FIG. 23 is a diagram showing a third example of the startup operation in the fourth embodiment. As with FIGS. 21 and 22 described above, the figure shows, sequentially from above, the output voltage VOUT, the mode control signal S1, the overheat protection signal TSD and the output current IOUT.

Simulation conditions in the figure are that the inductance value Lwire of the wire harness=2.5 μH, the resistance value Rwire of the wire harness=5 m Ω, the power supply voltage VB=14 V and the ambient temperature Ta=25 °C. Specifically, each of the inductance value Lwire and the resistance value Rwire of the wire harness is set to 2.5 times the value in FIG. 22 described above.

Under the simulation conditions described above, in times t81 to t82, the semiconductor device 1 is in the capacitive load drive mode (S1=H). However, at time t82, the capacitive load drive mode is completed immediately after the output voltage VOUT starts to increase. Consequently, in the figure, after time t82, in the intermediate mode described above, the overcurrent protection operation and the overheat protection operation are performed five times (see circles for output current IOUT). Here, at shorter intervals than in the normal hiccup operation, the power MISFET 9 is forcibly turned off and released in a repeated manner. Hence, after time t82, the output voltage VOUT is increased to around the power supply voltage VB.

Among the intervals during which the power MISFET 9 is forcibly turned off and released in a repeated manner, relatively short intervals are caused by the response speed of the detection circuit 231, and relatively long intervals are caused by the response speed of the overheat protection circuit 36.

### Application Example to Low-Side Switch IC

Although in the embodiments described above, the high-side switch IC which replaces mechanical fuses is shown as an example, the target on which the capacitive load drive mode is implemented is not limited to the high-side switch IC. For example, the capacitive load drive mode can be widely implemented on other IPDs.

For example, the power MISFET 9 described above may be provided as a low-side switch element which electrically conducts or interrupts between the output electrode to which an end of the load is connected and the reference voltage electrode to which the reference voltage (for example, the ground voltage) is applied.

In this case, the mode control circuit 53 may set the operation mode to the capacitive load drive mode when the output voltage VOUT applied to the output electrode is greater than a predetermined threshold voltage Vth′, and may set the operation mode to the normal mode when the output voltage VOUT is lower than the threshold voltage Vth′.

The threshold voltage Vth′ may be a voltage (=GND+Vy) which is generated with reference to the reference voltage (for example, the ground voltage). In other words, the threshold voltage Vth′ may be different from the threshold voltage Vth (=VB−Vx) described previously which is generated with reference to the power supply voltage VB.

### Application to Vehicle

FIG. 24 is an external view showing an example of the configuration of a vehicle. The vehicle X of the present configuration example incorporates various electronic devices which receive supply of power from a battery to operate.

The vehicle X includes not only engine vehicles but also electric vehicles (xEVs such as a BEV [battery electric vehicle], a HEV [hybrid electric vehicle], a PHEV/PHV [plug-in hybrid electric vehicle/plug-in hybrid vehicle] and an FCEV/FCV [fuel cell electric vehicle/fuel cell vehicle]).

The semiconductor device 1 described previously can be installed in any one of the electronic devices incorporated in the vehicle X.

### Additional Remarks

The disclosure described above will be additionally remarked below. According to the present disclosure, it is possible to appropriately drive a capacitive load without impairing an abnormality protection function.

### Additional Remark 1

A semiconductor device (1) includes: an output switch (9); and an overcurrent protection circuit (34) configured to detect an output current (IOUT) flowing through the output switch (9) to perform overcurrent protection, the overcurrent protection circuit (34) restricts the output current (IOUT) to a first overcurrent protection threshold value (IocpL) or less until either of two time points arrives earlier, one of the two time points is a time point at which a first time (T1) has elapsed after reception of an instruction to turn on the output switch (9) and the other of the two time points is a time point at which a voltage (Vds) across the output switch (9) falls below a detection threshold value (Vx), when the voltage (Vds) across the output switch (9) falls below the detection threshold value (Vx) before the first time (T1) has elapsed after the reception of the instruction to turn on the output switch (9), the overcurrent protection circuit (34) forcibly turns off the output switch (9) if the output current (IOUT) exceeds a second overcurrent protection threshold value (IocpH) greater than the first overcurrent protection threshold value (IocpL), and releases the forcibly turning off of the output switch (9) if the output current (IOUT) falls below the second overcurrent protection threshold value (IocpH) and after either of two time points arrives earlier, the overcurrent protection circuit (34) forcibly turns off the output switch (9) if the output current (IOUT) exceeds the second overcurrent protection threshold value (IocpH), and releases the forcibly turning off of the output switch (9) if a second time T2) has elapsed, one of the two time points is the time point at which the first time (T1) has elapsed after the reception of the instruction to turn on the output switch (9) and the other of the two time points is a time point at which a number of times the output switch (9) is forcibly turned off after the voltage (Vds) across the output switch (9) falls below the detection threshold value (Vx) reaches an upper limit value.

Additional remark 2

In the semiconductor device (1) according to the additional remark 1, the overcurrent protection circuit (34) includes: a detection circuit (341) configured to output a first internal signal (S11) corresponding to a result of a comparison between the output current (IOUT) and the second overcurrent protection threshold value (IocpH) after the voltage (Vds) across the output switch (9) falls below the detection threshold value (Vx); a control circuit (342) configured to generate a pulse in a second internal signal (S12) when either of two time points arrives earlier, and to output, after the either of the two time points arrives earlier, the first internal signal (S11) or a signal in synchronization with the first internal signal (Q1) as the second internal signal (S12), one of the two time points is the time point at which the first time (T1) has elapsed after the reception of the instruction to turn on the output switch (9) and the other of the two time points is a time point at which a number of times the pulse is generated in the first internal signal (S11) reaches the upper limit value; and an output circuit (343) configured to receive both an input of the first internal signal (S11) and an input of the second internal signal (S12) to generate a forcible-off signal S34 for forcibly turning off the output switch (9) and the forcible-off signal (S34) is maintained at a logic level in an off state for the second time (T1) after the pulse is generated in the second internal signal (S12).

### Additional Remark 3

In the semiconductor device (1) according to the additional remark 2, the control circuit (342) includes: a counter (CNT) configured to generate a pulse in an upper limit count reaching signal (S21) when the number of times the pulse is generated in the first internal signal (S11) reaches the upper limit value; and a multiplexer (MUX) configured to output the upper limit count reaching signal (S21) as the second internal signal (S12) until either of two time points arrives earlier, and to output, after the either of the two time points arrives earlier, the first internal signal (S11) or a signal in synchronization with the first internal signal (S11) as the second internal signal (S12), one of the two time points is the time point at which the first time (T1) has elapsed after the reception of the instruction to turn on the output switch (9) and the other of the two time points is a time point at which the pulse is generated in the upper limit count reaching signal (S21).

### Additional Remark 4

The semiconductor device (1) according to any one of the additional remarks 1 to 3 further comprising: an overheat protection circuit (36) configured to detect a temperature to be monitored (Temp1, ΔTemp) to perform overheat protection.

### Additional Remark 5

In the semiconductor device (1) according to the additional remark 4, until either of two time points arrives earlier, the overheat protection circuit (34) forcibly turns off the output switch (9) if the temperature to be monitored (Temp1, ΔTemp) exceeds a first overheat protection threshold value (TtsdL), and releases the forcibly turning off of the output switch (9) if the temperature to be monitored (Temp1, ΔTemp) falls below the first overheat protection threshold value (TtsdL), one of the two time points is the time point at which the first time (T1) has elapsed after the reception of the instruction to turn on the output switch (9) and the other of the two time points is the time point at which the voltage (Vds) across the output switch (9) falls below the detection threshold value (Vx), and after either of two time points arrives earlier, the overheat protection circuit (36) forcibly turns off the output switch (9) if the temperature to be monitored (Temp1, ΔTemp) exceeds a second overheat protection threshold value (TtsdH) greater than the first overheat protection threshold value (TtsdL), and releases the forcibly turning off of the output switch (9) if the temperature to be monitored (Temp1, ΔTemp) falls below the second overheat protection threshold value (TtsdH), one of the two time points is the time point at which the first time (T1) has elapsed after the reception of the instruction to turn on the output switch (9) and the other of the two time points is the time point at which the voltage (Vds) across the output switch (9) falls below the detection threshold value (Vx).

### Additional Remark 6

In the semiconductor device (1) according to the additional remark 4 or 5, the temperature to be monitored (Temp1, ΔTemp) is a first temperature (Temp1) that is detected in a power element region including the output switch (9) or a temperature difference (ΔTemp) between the first temperature (Temp1) and a second temperature (Temp2) that is detected in a region other than the power element region.

Additional remark 7

The semiconductor device (1) according to any one of the additional remarks 1 to 6 further comprising: a high-speed turn-off circuit (60) configured to turn off the output switch (9) when an abnormality is detected faster than when no abnormality is detected.

Additional remark 8

In the semiconductor device (1) according to any one of the additional remarks 1 to the output switch (9) is a high-side switch configured to electrically conduct or interrupt between a power supply electrode (11) and an output electrode (12) or a low-side switch configured to electrically conduct or interrupt between the output electrode (12) and a reference voltage electrode (14).

Additional remark 9

An electronic device (B) includes: the semiconductor device (1) according to any one of the additional remarks 1 to 8; and a load (B10) connected to the semiconductor device.

Additional remark 10

A vehicle (X) includes the electronic device (B) according to the additional remark

### Others

In various technical features disclosed in the present specification, in addition to the embodiments described above, various changes can be added without departing from the spirit of the technical creation. In other words, it should be considered that the embodiments described above are illustrative in all respects, and not restrictive. It is understood that the technical scope of the present disclosure is not limited to the embodiments described above and includes meanings equivalent to the scope of claims and all changes in the scope.

1. A semiconductor device comprising:
an output switch; and
an overcurrent protection circuit configured to detect an output current flowing through the output switch to perform overcurrent protection,
wherein the overcurrent protection circuit restricts the output current to a first overcurrent protection threshold value or less until either of two time points arrives earlier,
one of the two time points is a time point at which a first time has elapsed after reception of an instruction to turn on the output switch and the other of the two time points is a time point at which a voltage across the output switch falls below a detection threshold value,
when the voltage across the output switch falls below the detection threshold value before the first time has elapsed after the reception of the instruction to turn on the output switch, the overcurrent protection circuit
forcibly turns off the output switch if the output current exceeds a second overcurrent protection threshold value greater than the first overcurrent protection threshold value, and
releases the forcibly turning off of the output switch if the output current falls below the second overcurrent protection threshold value and
after either of two time points arrives earlier, the overcurrent protection circuit
forcibly turns off the output switch if the output current exceeds the second overcurrent protection threshold value, and
releases the forcibly turning off of the output switch if a second time has elapsed,
one of the two time points is the time point at which the first time has elapsed after the reception of the instruction to turn on the output switch and
the other of the two time points is a time point at which a number of times the output switch is forcibly turned off after the voltage across the output switch falls below the detection threshold value reaches an upper limit value.

2. The semiconductor device according to claim 1,
wherein the overcurrent protection circuit includes:
a detection circuit configured to output a first internal signal corresponding to result of a comparison between the output current and the second overcurrent protection threshold value after the voltage across the output switch falls below the detection threshold value;
a control circuit configured
to generate a pulse in a second internal signal when either of two time points arrives earlier, and
to output, after the either of the two time points arrives earlier, the first internal signal or a signal in synchronization with the first internal signal as the second internal signal,
one of the two time points is the time point at which the first time has elapsed after the reception of the instruction to turn on the output switch and the other of the two time points is a time point at which a number of times the pulse is generated in the first internal signal reaches the upper limit value; and
an output circuit configured to receive both an input of the first internal signal and an input of the second internal signal to output a forcible-off signal for forcibly turning off the output switch and
the forcible-off signal is maintained at a logic level in an off state for the second time after the pulse is generated in the second internal signal.

3. The semiconductor device according to claim 2,
wherein the control circuit includes:
a counter configured to generate a pulse in an upper limit count reaching signal when the number of times the pulse is generated in the first internal signal reaches the upper limit value; and
a multiplexer configured
to output the upper limit count reaching signal as the second internal signal until either of two time points arrives earlier, and
to output, after the either of the two time points arrives earlier, the first internal signal or a signal in synchronization with the first internal signal as the second internal signal,
one of the two time points is the time point at which the first time has elapsed after the reception of the instruction to turn on the output switch and
the other of the two time points is a time point at which the pulse is generated in the upper limit count reaching signal.

4. The semiconductor device according to claim 1 further comprising:
an overheat protection circuit configured to detect a temperature to be monitored to perform overheat protection.

5. The semiconductor device according to claim 4,
wherein until either of two time points arrives earlier, the overheat protection circuit
forcibly turns off the output switch if the temperature to be monitored exceeds first overheat protection threshold value, and
releases the forcibly turning off of the output switch if the temperature to be monitored falls below the first overheat protection threshold value,
one of the two time points is the time point at which the first time has elapsed after the reception of the instruction to turn on the output switch and
the other of the two time points is the time point at which the voltage across the output switch falls below the detection threshold value, and
after either of two time points arrives earlier, the overheat protection circuit
forcibly turns off the output switch if the temperature to be monitored exceeds second overheat protection threshold value greater than the first overheat protection threshold value, and
releases the forcibly turning off of the output switch if the temperature to be monitored falls below the second overheat protection threshold value,
one of the two time points is the time point at which the first time has elapsed after the reception of the instruction to turn on the output switch and
the other of the two time points is the time point at which the voltage across the output switch falls below the detection threshold value.

6. The semiconductor device according to claim 4,
wherein the temperature to be monitored is a first temperature that is detected in a power element region including the output switch or a temperature difference between the first temperature and a second temperature that is detected in a region other than the power element region.

7. The semiconductor device according to claim 1 further comprising:
a high-speed turn-off circuit configured to turn off the output switch when an abnormality is detected faster than when no abnormality is detected.

8. The semiconductor device according to claim 1,
wherein the output switch is a high-side switch configured to electrically conduct or interrupt between a power supply electrode and an output electrode or a low-side switch configured to electrically conduct or interrupt between the output electrode and a reference voltage electrode.

9. An electronic device comprising:
the semiconductor device according to claim 1; and
a load connected to the semiconductor device.

10. A vehicle comprising the electronic device according to claim 9.
